(19) United States
(12) Patent Application Publication
(10) Pub. No.: US 2012/0238439 A1
(43) Pub. Date: Sep. 20, 2012

(54) SILICON-RICH ALLOYS

(75) Inventors: Christopher A. Schuh, Ashland, MA (US); David S. Fischer, Houston, TX (US)

(73) Assignee: Massachusetts Institute of Technology, Cambridge, MA (US)

(21) Appl. No.: 13/391,505

(22) PCT Filed: Aug. 19, 2010
(86) PCT No.: PCT/US2010/002271

§ 371 Date: Jun. 5, 2012

Related U.S. Application Data
(60) Provisional application No. 61/235,757, filed on Aug. 21, 2009.

(51) Int. Cl. C04B 35/58; C03B 19/02; C22C 28/00

(52) U.S. Cl. 501/154; 420/578; 65/66

(57) ABSTRACT

Castable silicon-based compositions have enhanced toughness and related properties compared to silicon. The con-based compositions comprise silicon at a concentration greater than 50% by weight and one or more additional elements in structure comprising a cubic silicon phase and an additional phase which may impart toughness through mechanisms related to plastic flow or crack interaction with interfacial boundaries.

### CROSS-REFERENCE TO RELATED APPLICATIONS

The present application claims the benefit of U.S. Provisional Patent Application Ser. No. 61/235,757, which was filed on Aug. 21, 2009, by Christopher A. Schuh et al. for SILICON-RICH ALLOYS and is hereby incorporated by reference.

### BACKGROUND OF THE INVENTION

1. Field of the Invention

This invention relates to multiphase silicon-based compositions of matter. In particular this invention relates to high-silicon composites exhibiting enhanced toughness compared to silicon.

2. Background Information

Traditional brittle metals such as cast iron find wide use in components calling for moderate toughness for functioning under compressive loading, for example a brake pad or an engine block. Engineering ceramics may provide a relatively lightweight alternative to metals for such uses. However, conventional engineering ceramics are not formable through relatively inexpensive and straightforward processes such as casting. Instead, an engineering ceramic component is conventionally formed through a complex multi-operation series beginning with a green compact which is ultimately sintered at high temperatures to develop the microstructure required by the application. The resulting components are therefore expensive. There is, accordingly, a need for moderately tough materials that are both inexpensively produced and lightweight.

### SUMMARY OF THE INVENTION

In one embodiment, an object is formed by melting silicon and at least one element together to form a liquid having a silicon concentration greater than 50% silicon by weight; disposing the liquid in a mold; and cooling the liquid in the mold to form simultaneously cubic silicon and a silicide arranged in a eutectic aggregation. The eutectic aggregation constitutes at least eighty percent of the volume of the object.

In another embodiment, a method of forming a cast object comprises melting silicon and at least one element together to form a liquid having a silicon concentration greater than 50% silicon by weight; disposing the liquid in a mold; and cooling the liquid in the mold to form simultaneously cubic silicon and a silicide arranged in a eutectic aggregation constituting at least 80% by volume of the object.

In another embodiment a composition of matter comprises a phase of cubic silicon and a phase comprising a first element other than silicon. The phases are arranged together in a eutectic aggregation constituting 80% or more of the composition of matter by volume. The composition of matter exhibits a rising R-curve and has a silicon concentration greater than 50% by weight.

In another embodiment a composition of matter comprises a phase of cubic silicon and a first silicide phase comprising a first element other than silicon. The phases are arranged together in a eutectic aggregation constituting 80% or more of the composition of matter by volume. The eutectic aggregation has a characteristic spacing λ. The composition of matter has a silicon concentration greater than 50% by weight, a thickness greater than 10λ, and a fracture toughness greater than 2 MPa m^{1/2}.

In another embodiment, a composition of matter comprises a phase of cubic silicon and a first silicide phase comprising a first element other than silicon, the phases being arranged together in a eutectic aggregation constituting 80% or more of the composition of matter by volume. The eutectic aggregation has a characteristic spacing λ. The composition of matter has a silicon concentration greater than 50% by weight and a thickness greater than 100λ.

In another embodiment a composition of matter comprises a phase of cubic silicon and a first disilicide phase comprising a first element other than silicon, the phases being arranged together in a eutectic aggregation constituting 80% or more of the composition of matter by volume, the eutectic aggregation having a characteristic spacing λ. The composition of matter has a silicon concentration greater than 50% by weight and a thickness greater than 10λ.

In yet another embodiment, a composition of matter comprises silicon at a concentration greater than about 50% by weight. Silicon, vanadium, and chromium, are present at respective concentrations each within two atomic percent of respective concentrations of silicon, vanadium and chromium at a point on a curve joining a eutectic composition between silicon and vanadium disilicide and a eutectic composition between silicon and chromium disilicide, liquids lying on the curve undergoing eutectic solidification upon cooling. The composition of matter exhibits a rising R-curve.

### BRIEF DESCRIPTION OF THE DRAWINGS

The invention description below refers to the accompanying drawings, wherein identical reference symbols designate like structural or functional elements, and of which:

FIG. 1 is a binary phase diagram of the silicon-vanadium system;

FIG. 2 is a binary phase diagram of the silicon-chromium system;

FIG. 3 shows experimentally determined boundary points and a calculated monovariant line separating fields of primary silicon and primary mixed disilicide in a silicon-rich region of the silicon-vanadium-chromium ternary triangle;

FIG. 4 shows calculated liquidus isotherms in a silicon-rich region of the silicon-vanadium-chromium ternary triangle;

FIG. 5 shows the relationship between loading, rotation, cracking and orientation of lamellae during wear testing of specimens of illustrative compositions of the invention;

FIG. 6 shows notch parameters for a chevron-notched beam toughness test;

FIG. 7 graphically depicts loading versus extension for silicon during chevron-notched beam toughness testing;

FIG. 8 graphically depicts loading versus extension for silicon carbide during chevron-notched beam toughness testing;

FIG. 9 shows the relationships between specimen orientations and notch planes in an ingot of an illustrative composition of the invention;

FIG. 10 graphically depicts loading versus extension for an illustrative composition of the invention during chevron-notched beam toughness testing;

FIGS. 11A and 11B are micrographs showing phase distribution in alloy A, an illustrative composition of the invention;

FIGS. 12A and 12B are micrographs showing phase distribution in alloy B, an illustrative composition of the invention;

FIGS. 13A and 13B are micrographs showing phase distribution in alloy C, an illustrative composition of the invention;

FIGS. 14A and 14B are micrographs showing phase distribution in a specimen of alloy D, an illustrative composition of the invention, machined from the center of an ingot;

FIGS. 15A and 15B are micrographs showing phase distribution in a specimen of alloy D, an illustrative composition of the invention, machined from the side of an ingot in a third specimen orientation;

FIGS. 16A and 16B are micrographs showing phase distribution in a specimen of alloy D, an illustrative composition of the invention, machined from the side of an ingot in a second specimen orientation;

FIGS. 17A and 17B are micrographs showing phase distribution in a specimen of alloy D, an illustrative composition of the invention, machined from the side of an ingot in a third specimen orientation;

FIG. 18 is a binary phase diagram of the silicon-silver system;

FIG. 19 is a binary phase diagram of the silver-chromium system;

FIG. 20 is a micrograph showing phase distribution in an illustrative silicon-chromium-silver composite of the invention;

FIG. 21 is a binary phase diagram of the silicon-tin system;

FIG. 22 is a binary phase diagram of the tin-chromium system; and

FIG. 23 is a micrograph showing phase distribution in an illustrative silicon-chromium-tin composite of the invention.

Features in the figures are not, in general, drawn to scale. Binary phase diagram data in the drawings are taken from H. Okamoto, Phase Diagrams for Binary Alloys, Desk Handbook 2000.

### DETAILED DESCRIPTION OF ILLUSTRATIVE EMBODIMENTS

Silicon is abundant, lightweight, and extremely strong. However, the covalently bonded structure of silicon inhibits accommodation of deformation through dislocation plasticity. Instead, silicon generally fails through brittle, transgranular fracture. Consequently, silicon has a low fracture toughness at room temperature—on the order of 0.8-1.0 MPa·m^{1/2}. This poor toughness has limited its use to low-stress applications such as semiconductor and photovoltaic devices.

By contrast, the illustrative compositions of matter incorporate silicon at a concentration greater than, for example, 50%, 60%, or 75% or more by weight while exhibiting toughness values on par with structural ceramics or brittle metals. Thus the illustrative compositions exploit the low density, cost and castability of silicon-based materials while delivering desirable mechanical properties.

In one approach the silicon-based alloy or composite is a bulk material having a composite microstructure comprising at least two brittle phases: silicon in the diamond-cubic structure and at least one other phase that contains one or more elements other than silicon. It is understood that the diamond-cubic silicon phase may incorporate alloying or impurity elements. The one or more elements in the other phase may be combined with silicon to form a silicide. The silicide phase may be a silicide of a metallic element, more particularly of a transition metal. As used herein a metallic element is an element in one of groups 1 through 12 of the periodic table and “transition metal” refers to an element in the d-block of the periodic table, groups 3 to 12. Furthermore, “silicide” may mean a monosilicide, disilicide, other stoichiometric combinations, or nonstoichiometric combinations of silicon with at least one other element.

Without being bound by any theory, the one or more other phases in the composite may serve to reinforce the silicon phase when the composite is under stress. Illustratively the phase other than cubic silicon in the microstructure has high strength, and tensile stresses at the interfaces between the silicon phase and the high-strength silicide phase are high. The brittle-brittle microstructure may increase the composite toughness over that of silicon by providing obstacles to advancing cracks in the form of phase boundaries. The obstacles may cause the crack plane orientation to change, for example due to crack tilting or twisting, during crack propagation.

Crack deflection around a silicide phase, in particular along the silicon-silicide interface, may lead to crack bridging events in which intact silicide particles extend between crack surfaces behind a crack front. Illustratively, interfaces between cubic silicon and the silicide are capable of delaminating when encountered by a crack. As the crack continues to propagate, silicide particles become debonded and pulled out from the silicon. This type of elastic crack bridging may make it more difficult for the crack to open under an applied stress, and thus improve the fracture toughness and related properties of the alloys compared to unalloyed silicon.

Accordingly, the illustrative composites may have fracture toughness values on the order of several hundred percent of that of silicon, for example greater than, e.g., 1.2, 2, 3, 4, 5, 6 MPa m^{1/2} or a higher value as measured by, for example, the chevron-notched beam method or calculated from measurements of other material properties. Alternatively, the fracture toughness of the illustrative composite, determined by a particular method, may be greater than twice that of silicon, determined by same method. The illustrative composites may have specific wear rates on the order of 50% or less that of silicon, for example less than 5×10⁻¹⁴ m²/N, 2×10⁻¹⁴ m²/N, 1×10⁻¹⁴ m²/N or lower. Specific wear rates may be determined by, e.g., a ball-on-disk test with a tungsten carbide counterbody.

Illustratively, in at least part of the composite the multiple brittle phases are arranged in an interconnected or alternating configuration. The composite may comprise identifiable expanses within which the silicon phase and the other phase are aggregated in a structure typical of eutectic solidification. Eutectic structures known to those skilled in the art include, for example, normal structures such as a lamellar structure consisting of regularly spaced plate-like distinct phases with a shared growth direction contained at an interface, or a fibrous structure in which the regularly spaced phases are rod-like with a polygonal cross-section; and anomalous structures, in which there may be no prevalent, global orientation relationship between the distinct phases. Anomalous eutectic structures include irregular, broken lamellar, fibrous, complex regular, Chinese script, and quasi-regular structures.

As used herein, “eutectic” encompasses a reaction in which a liquid solidifies to form two or more distinct solid phases simultaneously, or to the liquid composition at which such a reaction occurs, and “eutectic aggregation” refers to the sum of expanses in the silicon-based composite within which the phases are configured in a eutectic-type structure. Such expanses illustratively occupy at least 80%, 85%, 90%, 95% or more of the volume of the silicon-based composite.

In one embodiment, the eutectic aggregation constitutes substantially the entirety of the composite. A high volume percentage of the composite occupied by such interconnected structures corresponds to a high brittle-brittle interfacial area available to interact with cracks in the material. Furthermore, a particular one of the two or more brittle phases may constitute a significant volume fraction of the eutectic aggregation in the composite, for example, more than 10%, 15%, 20%, 25%, 30% or 40% by volume of the material in the eutectic aggregation.

Within the eutectic aggregation in the silicon-based composite the configuration of the multiple phases may have a characteristic wavelength or spacing λ, as understood by those skilled in the art. The characteristic spacing may vary with location in the eutectic aggregation. A smaller spacing λ correlates with a greater density of interfacial area available to interact with cracks. The average value of the characteristic spacing illustratively may be less than 80 μm, 50 μm, 40 μm, 30 μm, 20 μm, 10 μm, 5 μm or a smaller value, as determined, for example, by a line-intercept method as known to those skilled in the art.

The silicon-based compositions of matter described herein may be bulk composites generally capable of being used as stand-alone materials, not only as coatings or relatively thin layers. The structure of the silicon-based composite may accordingly be sufficiently thick, for example at least 10, 50, 100 or 1000 times the characteristic spacing λ, in some dimension, to afford a relatively large number of interactions between interfaces in the composite microstructure and an advancing crack. As a result, the resistance to crack propagation through the material rises as the crack lengthens, so that the material is said to have a rising R-curve. As is known to those skilled in the art, a material having such a rising R-curve may exhibit stable crack extension, or propagation, under stress rather than the catastrophic fracture common in brittle materials such as silicon or some ceramics. Stable crack extension in a material having a rising R-curve may be demonstrated using techniques known to those skilled in the art, e.g., the chevron-notched beam method or the compact-tension test, which simulate long-crack behavior; the surface crack in flexure method which simulates short-crack behavior; or the precracked beam method, which can simulate long- or short-crack behavior depending on the precracking conditions as noted in ASTM C1421.

The efficacy of the eutectic aggregation in imparting toughness to the illustrative composite may in general depend on the orientation of the eutectic structure with respect to a crack in the material. For example, orientation of a reinforcing phase perpendicular to a crack may constitute a greater obstacle to crack propagation than a parallel orientation. The structure of the eutectic aggregation may illustratively be substantially similarly oriented, or mutually aligned, within regions, or throughout the entirety, of the composite, promoting anisotropy of its mechanical properties. Alternatively, the eutectic aggregation may comprise local domains of respective diverse orientations within a region, or throughout the entirety, of the composite for enhanced isotropy. In this case, as a crack propagates through the illustrative composite it may successively encounter regions of varying crack resistance. Thus the structure may provide for activation of microstructural toughening mechanisms, such as crack bridging, before excessive crack growth can occur. The distribution of structure orientation in effect may minimize the extent of crack growth that occurs before the toughening mechanisms of the composite are activated, supporting the realization of significant rising R-curve behavior.

Microstructural variables that may influence fracture toughness of the illustrative silicon-based composites such the volume fraction and spacing of the phase other than cubic silicon, phase morphology and orientation in the eutectic aggregation, and the presence of primary or overgrown silicon regions can not necessarily be controlled independently of one another. For example, for a given one or more constituent elements other than silicon, it may be desirable to select a composition compromising the volume fraction of the reinforcing phase in order to gain properties associated with a greater diversity of eutectic orientation, for example by promoting formation of an irregular eutectic structure. At the same time, a lower volume fraction of the reinforcing phase may be associated with a greater volume occupied by overgrown silicon, which provides low energy fracture paths that may degrade the overall toughness delivered by the illustrative composites. Reduction of silicon overgrowth may be achieved by tailoring the solidification process to decrease the growth velocity, but this change in turn increases the characteristic spacing in the eutectic aggregation. Composition and solidification process variables may be selected to optimize such competing considerations to produce a silicon-based composite having the desired features.

In another approach, the illustrative high-silicon composite may incorporate a ductile phase, capable of plastic flow, such as a metallically bonded element. The ductile phase may allow for dislocation plasticity and thus provide potential toughening by blunting crack tips or forming ductile bridges across crack faces. The ductile phase may be part of a eutectic microstructure or may constitute a separate proeutectoid region. In one embodiment, creating a ductile phase in a silicon-based composite may be accomplished by adding to silicon one or more alloying metals that do not form an intermediate compound with silicon, e.g., aluminum, lead, silver, or tin.

A ductile phase may also be incorporated in the illustrative brittle-brittle composites, thereby enhancing the toughness of the illustrative silicon-based composites over that afforded by a brittle-brittle microstructure alone. In this case, it may be desirable that the ductile alloying metals not form compounds with the elements combining with silicon to form the reinforcing brittle phases.

The silicon-based composition of matter is amenable to methods of forming objects thereof by casting processes. Thus objects of the illustrative composites described herein may be formed by melting silicon with one or more elements in appropriate proportions and then cooling the resulting liquid in a mold to form a solid incorporating the illustrative multiphase structure, for example by eutectic reaction. The mold may be a die or an investment produced from a model of an object to be formed. Methods of forming an object of the illustrative compositions of matter include, but are not limited to, e.g., die casting, sand casting, investment casting, continuous casting, and directional solidification. Thus embodiments of the method illustratively allow forming a final product of complex shape at relatively low cost compared to compositions produced by powder metallurgy processes. Realizing high-quality parts of complex shape may be further facilitated by a very low or zero net volume change upon solidification in forming the illustrative multiphase castings. For some compositions of the silicon-based composite, the expansion undergone by silicon upon solidification to form the cubic phase, on the order of 10%, may be somewhat compensated by shrinkage of other portions of the liquid upon formation of the one or more other phases.

Eutectic reactions by which the illustrative silicon-based composite may be produced include, e.g., solidification from a liquid having composition of an invariant reaction in a multi-component system to form a lamellar or anomalous multiphase structure; or solidification from a liquid having a composition lying on a boundary curve between invariant points, forming a normal or anomalous structure of composition varying as solidification proceeds along the boundary curve. Eutectic solidification may occur after primary solidification of a cubic silicon phase or a phase other than silicon. A nucleation agent may be added to the liquid so that the eutectic expanses do not preferentially grow from the mold walls but instead nucleate homogenously during solidification. The use of nucleation agent may therefore result in a microstructure including local domains of differing orientation of structures in the eutectic aggregation.

In one embodiment, the phase other than cubic silicon in the eutectic aggregation is one silicide phase, interconnected with the cubic silicon phase. The one silicide may be substantially of a single element, a first element, other than silicon. In this case, the first element other than silicon may exist in a binary system with silicon having a eutectic reaction forming silicon and a silicide phase. It may be desirable that the binary eutectic invariant point exist at high silicon concentration, for example greater than 50 atomic percent, 60 atomic percent, 75 atomic percent or more. Such high-silicon binary eutectic compositions carry the advantages of an overall high silicon content. Table 1 lists examples of silicides solidifying simultaneously with silicon from a binary melt and the corresponding eutectic compositions.

TABLE 1

| | | Eutectic |
|---|---|---|
| | | composition, |
| Group | Silicide | at % Si |
| 1 | Li₁₂Si₇ (transforms to Li_{4.7}Si₂ then Li₂₂Si₅) | 43 |
| 2 | Mg₂Si | 53 |
| | SrSi₂ | 80 |
| 3 | ScSi_{1.67} | 72 |
| | Ysi_{1.67} | 82 |
| 4 | TiSi₂ | 84 |
| | ZrSi₂ | 90 |
| | HfSi₂ | 90.8 |
| | ThSi₂ | 97 |
| 5 | VSi₂ | 97 |
| | NbSi₂ | 98 |
| | TaSi₂ | 96.4 |
| 6 | CrSi₂ | 87 |
| | MoSi₂ | 97 |
| | WSi₂ | 99 |
| 7 | Mn₁₁Si₁₉ | 66.4 |
| | ReSi_{1.75} | 90 |
| 8 | Fe_{0.92}Si₂ (transforms to FeSi₂) | 73.5 |
| | Ru₂Si₃ | 84 |
| | OsSi₂ | 88 |
| 9 | CoSi₂ | 77.5 |

Eutectic solidification producing the illustrative silicon-based composition of matter may be implemented beginning with a substantially binary liquid alloy having a composition intermediate to silicon and the silicide. For a liquid alloy initially at the silicon-silicide eutectic composition, the resulting composition of matter may be fully eutectic. For off-eutectic initial liquid alloy compositions the illustrative resulting solidified composite may include matter constituting a primary cubic silicon phase or a primary silicide phase, with concomitant reduction of the volume fraction of the composite occupied by expanses of the alternating eutectic structure.

The silicide formed in the eutectic reaction may be present at a relatively high volume fraction in the eutectic aggregation. Table 2 shows binary systems having eutectic reactions L→Si+MSi₂ forming silicon-disilicide eutectic structures. The listed binary silicon-disilicide structures, in particular Si—TaSi₂, Si—CrSi₂, Si—TiSi₂, and Si—CoSi₂, incorporate a significant volume fraction of the silicide phase.

TABLE 2

| | | | | Volume | |
|---|---|---|---|---|---|
| | Composition (wt. % Si) | | | fraction | |
| Eutectic Reaction | L | Si | MSi₂ | MSi₂ | Tₑ (° C.) |
| L → Si + MoSi₂ | 93.5 | 100 | 37 | 0.103 | 1400 |
| L → Si + WSi₂ | 93.8 | 100 | 23.4 | 0.081 | 1390 |
| L → Si + VSi₂ | 94.7 | 100 | 52.5 | 0.112 | 1400 |
| L → Si + NbSi₂ | 93.7 | 100 | 37.7 | 0.101 | 1395 |
| L → Si + TaSi₂ | 80.6 | 100 | 23.7 | 0.254 | 1395 |
| L → Si + CrSi₂ | 78.3 | 100 | 52.9 | 0.461 | 1335 |
| L → Si + TiSi₂ | 75.5 | 100 | 54.0 | 0.533 | 1330 |
| L → Si + CoSi₂ | 62.1 | 100 | 48.8 | 0.740 | 1259 |

In another embodiment, the one silicide phase may be a mixed silicide having substantial amounts of at least a second element, in addition to the first element, other than silicon. In this case, the first and second elements other than silicon may exist in respective binary systems with silicon, in which respective eutectic reactions form cubic silicon and the silicide respectively of the first and second elements. To enhance the volume fraction of the silicon-based composite occupied by the eutectic aggregation, silicon and elements other than silicon may be present in the silicon-based composite at respective concentrations close to those at which a eutectic reaction occurs in the ternary or higher-order system. For example, the composition of the composite may exist in composition space near a boundary curve joining two binary eutectic compositions: one of silicon and a silicide of the first element and the other of silicon and a silicide of the second element. Liquids having compositions lying on the curve undergo eutectic solidification upon cooling. The concentrations of constituent elements in the illustrative composite may be within one, two, or more atomic percent of respective concentrations describing a point on such a boundary curve.

If the two binary eutectic compositions occur at disparate silicon contents and/or have disparate volume fractions occupied by the binary eutectic aggregation or by the reinforcing silicide phase in the eutectic aggregation, it may be possible to tailor influential microstructural features by selection of the concentrations of the first and second elements. Inclusion of additional elements, e.g., a third element, third and fourth elements, or more elements other than silicon may afford further variables through which microstructural aspects of the illustrative compositions of matter may be manipulated.

Silicides of the first and second elements, and additional elements, may have the same crystal structure or be mutually soluble in all proportions. The mixed silicide in the illustrative composite may also have the common crystal structure. Silicides existing in the same crystal structure include, for example, nickel disilicide and cobalt disilicide, which have the cubic C1 structure in common; molybdenum disilicide, tungsten disilicide, and rhenium silicide have the tetragonal C11_{b} structure in common; zirconium disilicide and hafnium disilicide have the orthorhombic C49 structure; titanium disilicide has the orthorhombic C54 structure in common; vanadium disilicide, chromium disilicide, niobium disilicide, and tantalum disilicide have the hexagonal C40 structure in common and are mutually soluble in all proportions.

### EXAMPLES

### Phase Relationships

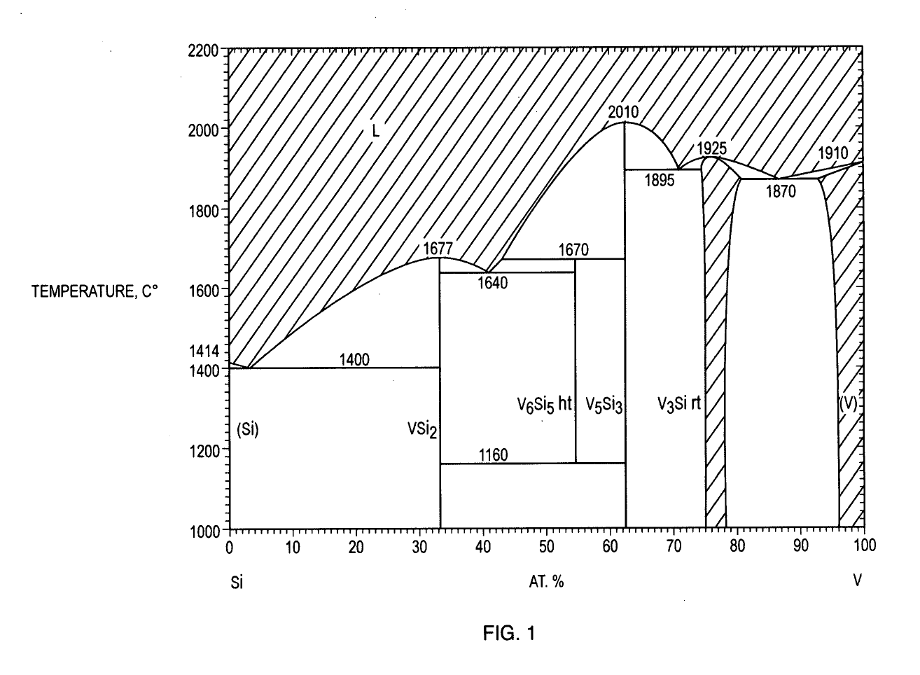

With reference to FIG. 1, in one case the first element other than silicon in the silicide phase is vanadium. Vanadium disilicide is 52.48% silicon by weight. A Si—VSi₂ eutectic reaction has been reported in the literature to occur at a composition C_{E,Si—VSi2} of 97 atomic percent silicon and a temperature T_{E,Si—VSi2} of 1400° C., as shown in FIG. 1. Earlier reports included values ranging from 1370° C. to 1415° C. The Si—VSi₂ eutectic structure is expected to be 11.2% VSi₂ by volume based on a tie-line calculation using the phase diagram in FIG. 1.

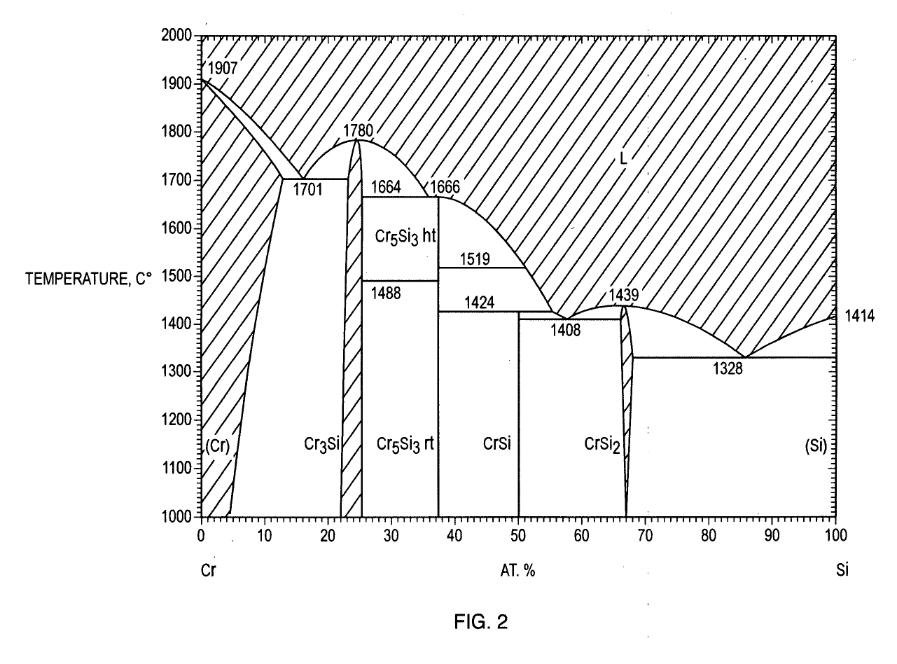

With reference to FIG. 2, in another case, the first element other than silicon in the silicide phase is chromium. Chromium disilicide is 51.97% silicon by weight. A Si—CrSi₂ eutectic reaction has been reported in the literature to occur at a composition C_{E,Si—CrSi2} of 87 atomic percent silicon and a temperature T_{E,Si—CrSi2} of 1328° C. The Si—CrSi₂ eutectic structure is expected to be 46.07% CrSi₂ by volume based on a tie-line calculation using the phase diagram in FIG. 2.

Illustrative composites having a mixed silicide phase in the eutectic aggregation may be formed by incorporating vanadium as a first element other than silicon and chromium as a second element other than silicon in a high-silicon composition of matter. It has been found that the disparate amounts of disilicide phase associated with the respective eutectic structures of the Si—VSi₂ and Si—CrSi₂ systems enables tailoring of the volume fraction of the reinforcing disilicide phase in the eutectic aggregation of the illustrative silicon-based composite over a relatively wide range by judicious selection of the global composition, e.g., of the liquid from which the composite is cast. Including one or more additional elements having disilicides existing in the C40 hexagonal crystal structure may introduce more composition variables by which properties of the two-phase eutectic aggregation containing vanadium, chromium and the additional elements.

Binary and ternary alloys in the Si—V—Cr system were investigated using thermal and microstructural methods. For every alloy tested, silicon granules (99.999%, Alfa Aesar product #38542) were combined with vanadium granules (99.7%, Alfa Aesar product #39693) and/or chromium powder (99.996%, Alfa Aesar product #10452) to constitute a sample. Each sample was placed in a 70-microliter alumina pan in a differential scanning calorimeter (“DSC”) for conventional thermal analysis known to those skilled in the art. The elements were melted together in the DSC at 1600° C. under flowing argon for 30 minutes, cooled to 1100° C. at a rate of 100° C./min, and held at 1100° C. for one hour before testing. Then the sample was heated to 1550° C. at a rate of 5° C./min. Phase transition temperatures were identified by the presence of endothermic peaks in the DSC scan. The peak temperature of the endothermic peak observed (or of the last, highest-temperature endothermic peak for alloys displaying multiple thermal signals) was taken to be the liquidus temperatures (Tₘ) for an alloy.

DSC scans were made as described for binary specimens containing from 94.00 to 97.60 atomic percent silicon with a balance of vanadium, with the liquidus temperatures (Tₘ) deduced therefrom reported in Table 3, and binary specimens containing from 75.00 to 96.00 atomic percent silicon with a balance of chromium, with the liquidus temperatures deduced therefrom reported in Table 4. Compositions exhibiting a single peak in the thermal signal were designated possible eutectic compositions for the respective binary systems.

TABLE 3

| Si (at. %) | V (at. %) | Tₘ (° C.) |
|---|---|---|
| 97.60 | 2.40 | 1395 |
| 97.00 | 3.00 | 1394 |
| 96.40 | 3.60 | 1385 |
| 96.01 | 3.99 | 1386 |
| 95.20 | 4.80 | 1386 |
| 94.00 | 6.00 | 1376 |

TABLE 4

| Si (at. %) | Cr (at. %) | Tₘ (° C.) |
|---|---|---|
| 96.00 | 4.00 | 1387 |
| 93.96 | 6.04 | 1375 |
| 88.80 | 11.20 | 1339 |
| 88.20 | 11.80 | 1344 |
| 87.91 | 12.09 | 1338 |
| 87.00 | 13.00 | 1341 |
| 86.40 | 13.60 | 1340 |
| 85.80 | 14.20 | 1341 |
| 79.80 | 20.20 | 1393 |
| 75.00 | 25.00 | 1430 |

Microstructural analysis was performed on the eutectic candidate samples identified by DSC, after sectioning using a low-speed diamond saw and polishing to a 0.06 μm finish. Micrographs of the sections were examined, as known to those skilled in the art, to identify a composition having a fully eutectic structure. This composition was taken as the binary eutectic composition for the respective system. The single peak temperature observed during the DSC ramp up of the eutectic composition sample was taken as the temperature of the invariant point for that binary eutectic composition. The binary Si—VSi₂ and Si—CrSi₂ eutectic compositions (C_{E}) and reaction temperatures (T_{E}) were found to be Si-3.99V (T_{E}=1386° C.) and Si-12.09Cr (T_{E}=1338° C.), respectively, showing good agreement with literature values reported above.

Micrographs for the Si—VSi₂ and Si—CrSi₂ binary eutectic alloys both showed fully or near-fully eutectic microstructures, with no primary or overgrown silicon or disilicide phase regions. A fibrous eutectic structure was observed for the Si—VSi₂ eutectic alloy. A colony type structure was observed for the Si—CrSi₂ eutectic alloy.

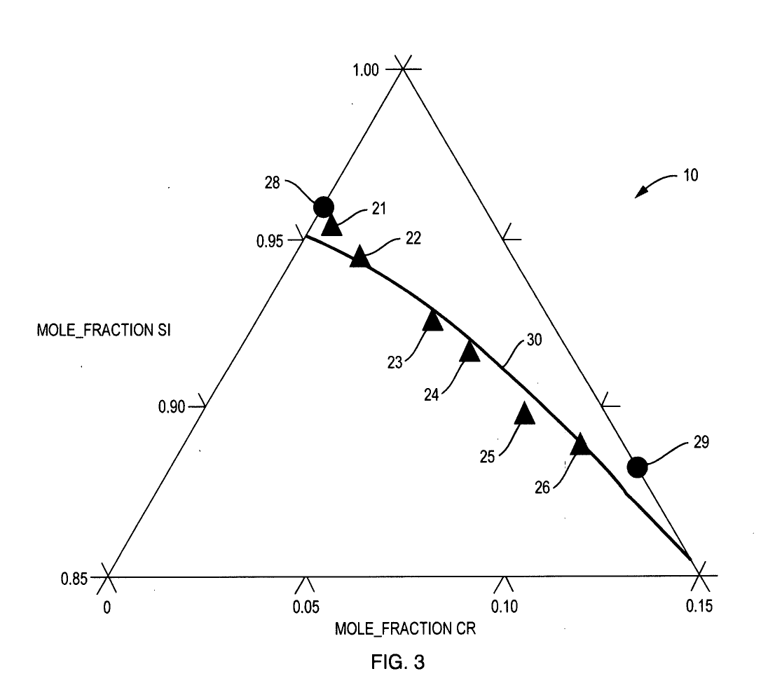

With reference to FIG. 3, phase equilibria in the silicon-rich region 10 near the silicon vertex of the Si—V—Cr ternary triangle were investigated experimentally. Several test compositions were selected on each of six silicon isopleths 11, 12, 13, 14, 15 and 16. On each of the isopleths 11 to 16 cooling a liquid having a composition nearer the Si—V side of the region 10 first yields primary mixed disilicide (V,Cr)Si₂, and cooling a liquid having a composition nearer the Si—Cr side of the region 10 first yields primary silicon. Liquid of some intermediate composition yields no primary phase but simultaneously forms a mixed disilicide (V,Cr)Si₂ and cubic silicon in a eutectic structure. Such a composition is referred to herein as a boundary point between the silicon and disilicide primary phase regions in the ternary triangle.

In order to estimate boundary points in the silicon-rich region 10, ternary specimens were prepared and subjected to thermal analysis as described above. An endothermic eutectic peak was observed for each alloy composition. Compared to peaks observed for the binary alloys, the signals due a solidification of a primary phase are less easily resolved. Discerning the point at which melting of the eutectic phase ends and melting of a primary phase begins may be difficult because the composition of the (Cr,V)Si₂ mixed disilicide phase is variable over the ternary phase field rather than constant as in a binary system. The variability of the disilicide composition upon solidification/melting renders endothermic peaks that are broader and flatter compared with a peak for a binary compound. For each isopleth, samples showing a single peak during the slow temperature ramp-up were further investigated as candidates for the boundary point composition for the isopleth. The liquidus temperatures calculated for compositions on the isopleths 11, 12, 13, 14, 15 and 16 are shown in Tables 5, 6, 7, 8, 9 and 10 respectively.

TABLE 5
Liquidus temperatures (Tₘ) on isopleth 11 (95.46 at. % Si)

| Cr (at. %) | V (at. %) | Tₘ (° C.) |
|---|---|---|
| 0.00 | 4.54 | 1394 |
| 0.23 | 4.31 | 1394 |
| 0.45 | 4.09 | 1388 |
| 0.91 | 3.63 | 1377 |
| 1.36 | 3.18 | 1378 |

TABLE 6
Liquidus temperatures (Tₘ) on isopleth 12 (94.51 at. % Si)

| Cr (at. %) | V (at. %) | Tₘ (° C.) |
|---|---|---|
| 0.55 | 4.94 | 1391 |
| 1.10 | 4.39 | 1386 |
| 1.65 | 3.84 | 1385 |
| 2.20 | 3.29 | 1387 |

TABLE 7
Liquidus temperatures (Tₘ) on isopleth 13 (92.62 at. % Si)

| Cr (at. %) | V (at. %) | Tₘ (° C.) |
|---|---|---|
| 2.95 | 4.43 | 1414 |
| 3.69 | 3.69 | 1405 |
| 4.43 | 2.95 | 1378 |
| 4.80 | 2.58 | 1379 |
| 5.17 | 2.21 | 1375 |
| 5.54 | 1.84 | 1377 |
| 5.90 | 1.48 | 1379 |

TABLE 8
Liquidus temperatures (Tₘ) on isopleth 14 (91.68 at. % Si)

| Cr (at. %) | V (at. %) | Tₘ (° C.) |
|---|---|---|
| 2.50 | 5.82 | 1446 |
| 3.33 | 4.99 | 1432 |
| 4.16 | 4.16 | 1410 |
| 4.99 | 3.33 | 1388 |
| 5.82 | 2.50 | 1372 |
| 6.66 | 1.66 | 1369 |

TABLE 9
Liquidus temperatures (Tₘ) on isopleth 5 (89.80 at. % Si)

| Cr (at. %) | V (at. %) | Tₘ (° C.) |
|---|---|---|
| 1.02 | 9.18 | 1501 |
| 2.04 | 8.16 | 1487 |
| 3.06 | 7.14 | 1468 |
| 4.08 | 6.12 | 1454 |
| 5.10 | 5.10 | 1447 |
| 6.12 | 4.08 | 1414 |
| 7.14 | 3.06 | 1405 |
| 8.16 | 2.04 | 1364 |
| 9.18 | 1.02 | 1358 |
| 10.20 | 0.00 | 1361 |

TABLE 10
Liquidus temperatures (Tₘ) on isopleth 6 (88.85 at. % Si)

| Cr (at. %) | V (at. %) | Tₘ (° C.) |
|---|---|---|
| 4.46 | 6.69 | 1461 |
| 5.57 | 5.57 | 1448 |
| 6.69 | 4.46 | 1415 |
| 7.80 | 3.35 | 1397 |
| 8.92 | 2.23 | 1380 |
| 10.03 | 1.12 | 1347 |

Microstructural analysis was performed on the tested candidate DSC samples, after sectioning using a low-speed diamond saw and polishing to a 0.06 μm finish. Micrographs of the sections made from the candidate samples on each isopleth were examined, as known to those skilled in the art, to identify a composition having a fully eutectic structure or a near-fully eutectic structure with a minimal amount of primary silicon or primary disilicide. This composition was taken as an estimate of the boundary point for the isopleth. The compositions at the respective boundary points 21, 22, 23, 24, and 26 estimated by complementary thermal and microstructural analysis are listed in Table 11.

TABLE 11

| Boundary point | Boundary point | | Melting |
|---|---|---|---|
| reference | composition | Boundary point composition | temperature |
| numeral | (atomic percent) | (wt. %) | (° C.) |
| 21 | 95.46Si—0.45Cr—4.09V | 92.05Si—0.80Cr—7.15V | 1388 |
| 22 | 94.51Si—1.65Cr—3.84V | 90.42Si—2.92Cr—6.66V | 1385 |
| 23 | 92.62Si—4.43Cr—2.95V | 87.24Si—7.72Cr—5.04V | 1378 |
| 24 | 91.68Si—5.82Cr—2.50V | 85.69Si—10.07Cr—4.24V | 1372 |
| 25 | 89.80Si—8.16Cr—2.04V | 82.68Si—13.91Cr—3.41V | 1364 |
| 26 | 88.85Si—6.66Cr—1.66V | 81.18Si—16.97Cr—1.85V | 1347 |

Phase equilibria in the Si—V—Cr system were also studied by thermodynamic is analysis using Thermo-Calc® software, based on the CALPHAD method, known to those skilled in the art. Equilibrium states as a function of composition and temperature were determined through global minimization of the total free energy of the material system. Values for Gibbs energies for the pure elements appearing in the model were taken from the SGTE compilation by Dinsdale (Dinsdale A T. Calphad-Computer Coupling of Phase Diagrams and Thermochemistry 1991; 15:317). Energies expressed below are in Joule/mol and temperatures T in degrees Kelvin.

The phases considered were a liquid, αCr₅Si₃, CrSi, V₅Si₃, V₆Si₅, a bcc-A2 solid solution, Cr₃Si, βCr₅Si₃, CrSi₂ and V₃Si. For each phase θ the molar Gibbs free energy was described by:

$${G}^{θ} - {\sum }_{i} {b}_{i} {H}_{i}^{SER} = {}_{}^{srf}{G}{}_{}^{θ} + {}_{}^{phys}{G}{}_{}^{θ} - {T}^{cnf} {S}^{θ} + {}_{ }^{E}{G}{}_{ }^{θ}$$

wherein the terms on the right hand side of the equation represent respectively the surface of reference energy of an unreacted mixture of elemental constituents of the phase θ, configurational entropy, and an excess Gibbs energy. The term

$${G}^{θ} - {\sum }_{i} {b}_{i} {H}_{i}^{SER}$$

is shown here to clarify that the Gibbs energy is for all phases are taken with respect to the same reference point for each element, where Hᵢ^{SER} is the molar enthalpy of the elements in their standard element reference states at 298.15 K and 1 bar and bᵢ is the stoichiometric factor of element i in the phase θ. This term is needed because there is no absolute value for the Gibbs energy.

The phases αCr₅Si₃, CrSi, V₅Si₃, and V₆Si₅ were modeled as stoichiometric solids for which the configurational entropy term is zero and

^{srf}G^{θ}=x_{A}⁰G_{A}(T)+x_{B}⁰G_{B}(T)

^{E}G^{θ}=ΔG_{f}^{A}^{ₘ}^{B}^{ₙ}(T)

(Ansara I, Dinsdale A T, Rand M H, editors. COST 507: Definition of thermochemical and thermophysical properties to provide a database for the development of new light alloys. Belgium, 1998). In the model x_{A} and x_{B} are the mole fractions of elements A and B consistent with the stoichiometry of the compound AₘBₙ; ⁰G_{A}(T) and ⁰G_{B}(T) are the Gibbs free energies of elements A and B with respect to their reference states (i.e., bcc for Cr and V and diamond cubic for Si); and ΔG_{f}^{A}^{ₘ}^{B}^{ₙ} (T) is the Gibbs energy of formation of the compound referred to the stable elements at temperature T. Table 12 shows the thermodynamic functions used for the modeled stoichiometric phases in the global free energy minimization computation.

TABLE 12
Free energy functions for line compounds

| | | Source |
|---|---|---|
| AₘBₙ | Free energy functions (J/mol) | reference |
| αCr₅Si₃ | ⁰G_{Cr:Si}^{αCr}^{₅}^{Si}^{₃} − 5H_{Cr}^{SER} − 3H_{Si}^{SER} = | Du |
| | −316,886.2 + 1,067.97713 · T − | |
| | 182.578184 · T · LN(T) − 0.023919688 · T² − | |
| | 2.31728 · 10⁻⁶ · T³ | |
| CrSi | ⁰G_{Cr:Si}^{CrSi} − H_{Cr}^{SER} − H_{Si}^{SER} = | Du |
| | −79,273.09 + 312.40316 · T − | |
| | 51.62865 · T · LN(T) − 0.00447355 · T² + | |
| | 391,330 · T⁻¹ | |
| V₅Si₃ | ⁰G_{V:Si}^{V}^{₅}^{Si}^{₃} − 3H_{Si}^{SER} − 5H_{V}^{SER} = −443,336.8 + | Zhang |
| | 53.40392 · T + 5 · GHSERV + 3 · GHSERSI | |
| V₆Si₅ | ⁰G_{V:Si}^{V}^{₆}^{Si}^{₅} − 5H_{Si}^{SER} − 6H_{V}^{SER} = −580,401.8 + | Zhang |
| | 65.04476 · T + 6 · GHSERV + 5 · GHSERSI | |

(Du Y, Schuster J C. Journal of Phase Equilibria 2000; 21:281 and Zhang C, Du Y, Xiong W, Xu H H, Nash P, Ouyang Y F, Hu RX. Calphad-Computer Coupling of Phase Diagrams and Thermochemistry 2008; 32:320.) GHSERV and GHSERSI are the lattice stabilities for pure vanadium and silicon, respectively, where GHSERi=⁰Gᵢ^{SER} (T)−Hᵢ^{SER} (298.15 K, 1 bar) (Dinsdale, as cited above). Standard element reference is abbreviated SER.

The liquid phase was modeled as a substitutional solution for which

$${}_{}^{srf}{G}{}_{}^{θ} = {\sum }_{i = 1}^{n} {x}_{i} {}_{}^{0}{G}{}_{i}^{θ} ( T )$$

$${}_{}^{cnf}{S}{}_{}^{θ} = - R {\sum }_{i = 1}^{n} {x}_{i} ln ( {x}_{i} )$$

$${}_{}^{E}{G}{}_{}^{θ} = {\sum }_{i} {\sum }_{j > i}^{ } {x}_{i} {x}_{j} {L}_{ij} ( T )$$

(Redlich O, Kister A T. Industrial and Engineering Chemistry 1948; 40:345). In the model xᵢ is the mole fraction of the constituent element i, ⁰Gᵢ^{θ}(T) is the Gibbs free energy of the element i that is in the solution phase (which are given by Dinsdale, as cited above), and R is the universal gas constant.

The excess Gibbs free energy term ^{E}G^{θ} for the solution phase includes the Redlich-Kister polynomial expression Lᵢⱼ(T), which is an interaction parameter between elements i and j that can be expressed as

$${L}_{ij} ( T ) = {\sum }_{v = 0}^{k} {( {x}_{i} - {x}_{j} )}^{v} \cdot {}_{ }^{v}{L}{}_{ij}^{ } ( T ) .$$

The solution model only accounts for pairwise interactions between constituent elements. Functions used to describe the interaction parameters ^{v}Lᵢⱼ(T) for Cr and Si (v=0, 1), Cr and V (v=0, 1) and Si and V (v=0, 1, 2) in the computational model for ^{E}G^{θ} are listed in Table 13. For compositions off the binaries, the Muggianu method was applied to adapt the functionality of ^{E}G^{θ} shown above to describe liquid compositions including to all three of Si, V and Cr, resulting in

^{E}G_{ternary}^{θ}=x_{A}x_{B}[⁰L_{AB}+¹L_{AB}(x_{A}−x_{B})]+x_{B}x_{C}[⁰L_{BC}+¹L_{BC}(x_{B}−x_{C})]+x_{A}x_{C}[⁰L_{AC}+¹L_{AC}(x_{A}−x_{C})]

### (Muggianu Y M, Gambino M, Bros J P. Journal De Chimie Physique Et De Physico-Chimie Biologique 1975; 72:83).

TABLE 13
Interaction parameter functions for liquid solution model

| Interaction parameter | Source reference |
|---|---|
| ⁰L_{Cr,Si}^{Liquid} = −126,112.28 + 19.92557 · T | Du |
| ¹L_{Cr,Si}^{Liquid} = −48,048.45 + 11.38497 · T | Du |
| ⁰L_{Cr,V}^{Liquid} = −9,874 − 2.6964 · T | Ansara |
| ¹L_{Cr,V}^{Liquid} = −1,720 − 2.5237 · T | Ansara |
| ⁰L_{Si,V}^{Liquid} = −190,326.8 + 44.06262 · T | Zhang |
| ¹L_{Si,V}^{Liquid} = 6,265.4 | Zhang |
| ²L_{Si,V}^{Liquid} = 39,546.5 | Zhang |

(Du and Zhang as cited above. Ansara I, Dinsdale A T, Rand M R, editors. COST 507: Definition of thermochemical and thermophysical properties to provide a database for the development of new light alloys. Belgium, 1998)

Phases modeled as ordered phases were designated to have sublattices as follows: bcc-A2 solid solution with (Cr,Si,V)₁(Vacancy)₁ sublattices; Cr₃Si with (Cr,Si)₃(Cr,Si)₁ sublattices; βCr₅Si₃ with (Cr,Si)₂(Cr,Si)₃(Cr)₃ sublattices; CrSi₂ with (Cr,Si,V)₁(Cr,Si)₂ sublattices and V₃Si with (Si,V)₃(Si,V)₁ sublattices. The respective surface of reference ^{srf}G^{θ} and configurational entropy ^{cnf}S^{θ} terms for the modeled ordered phases are

$${}_{}^{srf}{G}{}_{}^{θ} = {\sum }_{i} {\sum }_{j} {y}_{i}^{′} {y}_{j}^{″} {}_{ }^{0}{G}{}_{i : j}^{ } ( T )$$

$${}_{ }^{cnf}{S}{}_{ }^{θ} = - R ( m {\sum }_{i} {y}_{i}^{′} ln ( {y}_{i}^{′} ) + n {\sum }_{j} {y}_{j}^{″} ln ( {y}_{j}^{″} ) )$$

(Sundman B, Agren J. Journal of Physics and Chemistry of Solids 1981; 42:297 and Hillert M, Staffans Li. Acta Chemica Scandinavica 1970; 24:3618).

The colon in the subscript of ⁰G_{i:j}(T) identifies the distinct constituents on each of the sublattices. When the elements i and j are the same, ⁰G_{i:j}(T) represents the Gibbs energy of formation of the constituent elements; when the elements i and j are different, ⁰G_{i:j}(T) represents the Gibbs energy of formation of the compound AₘBₙ or BₘAₙ (where A and B correspond respectively to elements i and j). The functions used for the modeled ordered phases appear in Tables 15 through 18, in which GHSERV, GHSERSI and GHSERCR are the lattice stabilities for pure vanadium, silicon and chromium, respectively, where GHSERi=⁰Gᵢ^{SER}(T)−Hᵢ^{SER} (298.15 K, 1 bar) (Dinsdale, as cited above). Standard element reference is abbreviated SER.

The terms y′ᵢ and y″ⱼ are the constituent fractions on sublattices 1 and 2, respectively, and the factors m and n give the ratio of the sites on the two sublattices. For an ordered phase consisting of only two constituents which can exist on either of the two sublattices (i.e., (A,B)ₘ(A,B)ₙ), the excess free energy term is equal to

^{E}G^{θ}=y′_{A}y′_{B}[y″_{A}L_{A,B:A}(T)+y″_{B}L_{A,B:B}(T)]+y″_{A}y″_{B}[y′_{A}L_{A:A,B}(T)+y′_{B}L_{B:A,B}(T)]+y′_{A}y′_{B}y″_{A}y″_{B}L_{A,B:A,B}(T),

in which

$${L}_{ij} ( T ) = {\sum }_{v = 0}^{k} {( {x}_{i} - {x}_{j} )}^{v} \cdot {}_{ }^{v}{L}{}_{ij}^{ } ( T )$$

as presented above for the solution phase model. Analogous expressions for ^{E}G^{θ} were used for cases in which more than two constituents exist on one or both of the sublattices.

With the assumption that the interaction on each sublattice is independent of the occupation of the other sublattice, the interaction parameters used for the ordered phases have the form

$${L}_{A , B {:}^{*}} ( T ) = {\sum }_{v = 0}^{n} {( {y}_{A}^{′} - {y}_{B}^{′} )}^{v} \cdot {}_{ }^{v}{L}{}_{A , B {:}^{*}}^{ } ( T )$$

for a constituent designated as *. Expressions for ^{v} L_{A,B:*}(T) are tabulated in Tables 14 through 18. The Muggianu method, represented above for the liquid phase, was used for the ordered phases also.

TABLE 14
Interaction parameter functions in BCC-A2: (Cr,Si,V)₁(Vacancy)₁

| | Source |
|---|---|
| ^{v}L_{A,B:}*(T) | reference |
| ⁰L_{Cr,Si:Va}^{bcc-A2} = −104,537.94 + 10.69527 · T | Ansara |
| ¹L_{Cr,Si:Va}^{bcc-A2} = −47,614.7 + 12.17363 · T | Ansara |
| ⁰L_{Cr,V:Va}^{bcc-A2} = −9,875 − 2.6964 · T | Ansara |
| ¹L_{Cr,V:Va}^{bcc-A2} = −1,720 − 2.5237 · T | Ansara |
| ⁰L_{Si,V:Va}^{bcc-A2} = −205,373.1 + 61.02211 · T | Zhang |
| ¹L_{Si,V:Va}^{bcc-A2} = 37,000 | Zhang |
| ²L_{Si,V:Va}^{bcc-A2} = 20,000 | Zhang |

(Ansara and Zhang as cited above)

TABLE 15
Free energy functions for Cr₃Si: (Cr,Si)₃(Cr,Si)₁
(Du as cited above)

⁰G_{Cr:Si}^{Cr}^{₃}^{Si} − 4H_{Cr}^{SER} = 20,000 + 10 · T + 4 · GHSERCR
⁰G_{Cr:Si}^{Cr}^{₃}^{Si} − H_{Cr}^{SER} − 3H_{Si}^{SER} = 316,999.96 − 68.59964 · T +
GHSERCR + 3 · GHSERSI
⁰G_{Cr:Si}^{Cr}^{₃}^{Si} − 3H_{Cr}^{SER} − H_{Si}^{SER} = −115,442.82 − 1.40036 · T +
3 · GHSERCR + GHSERSI
⁰G_{Cr:Si}^{Cr}^{₃}^{Si} − 4H_{Si}^{SER} = 208,000 − 8 · T + 4 · GHSERSI
⁰L_{Cr,Si:Cr}^{Cr}^{₃}^{Si} = L_{Cr,Si:Si}^{Cr}^{₃}^{Si} = −9,661.46
⁰L_{Cr:Cr,Si}^{Cr}^{₃}^{Si} = ⁰L_{Si:Cr,Si}^{Cr}^{₃}^{Si} = −16,781.4

TABLE 16
Model functions for βCr₅Si₃: (Cr,Si)₂(Cr,Si)₃(Cr)₃
(Du as cited above)

⁰G_{Cr:Cr:Cr}^{βCr}^{₅}^{Si}^{₃} − 8 · ⁰G_{Cr}^{SER} = 40,000
⁰G_{Si:Cr:Cr}^{βCr}^{₅}^{Si}^{₃} − 2 · ⁰G_{Si}^{SER} − 2 · ⁰G_{Cr}^{SER} = 276,920 + 17.7412 · T
⁰G_{Cr:Si:Cr}^{βCr}^{₅}^{Si}^{₃} − ⁰G_{Cr:Si}^{αCr}^{₅}^{Si}^{₃} = 19,359.21 − 10.78731 · T
⁰G_{Si:Si:Cr}^{βCr}^{₅}^{Si}^{₃} − 5 · ⁰G_{Si}^{SER} − 3 · ⁰G_{Cr}^{SER} = 0

TABLE 17
Model functions for CrSi₂: (Cr,Si,V)₁(Cr,Si)₂

| | Source |
|---|---|
| Function | reference |
| ⁰G_{Cr:Cr}^{CrSi}^{₂} − 3H_{Cr}^{SER} = 10,000 − T + 3 · GHSERCR | Du |
| ⁰G_{Si:Cr}^{CrSi}₂ − 2H_{Cr}^{SER} − H_{Si}^{SER} = 174,006 − 27.21105 · T + | Du |
| 2 · GHSERCR + GHSERSI | |
| ⁰G_{Cr:Si}^{CrSi}^{₂} − H_{Cr}^{SER} − 2H_{Si}^{SER} = −100,352.65 + | Du |
| 336.777 · T − 57.85575 · T · LN(T) − 0.0132277 · T² − | |
| 4.3203 · 10⁻⁷ · T³ | |
| ⁰G_{Si:Si}^{CrSi}^{₂} − 3H_{Si}^{SER} = 82,389.75 − 24.68504 · T + | Du |
| 3 · GHSERSI | |
| ⁰G_{V:Si}^{CrSi}^{₂} − 2H_{Si}^{SER} − H_{V}^{SER} = −162,308.4 + | Zhang |
| 408.29196 · T − 67.8 · T · LN(T) − 0.0075 · T² + | |
| 330,000 · T⁻¹ | |
| ⁰G_{V:Cr}^{CrSi}^{₂} − 2H_{Cr}^{SER} − H_{V}^{SER} = 0.0 | |
| ⁰L_{Cr,Si:Cr}^{CrSi}^{₂} = ⁰L_{Cr,Si:Si}^{CrSi}^{₂} = 1435.7 | Du |
| ⁰L_{Si:Cr,Si}^{CrSi}^{₂} = ⁰L_{Cr:Cr,Si}^{CrSi}^{₂} = −35,879.97 + 7.17599 · T | Ansara |
| ⁰G_{Cr:Cr}^{CrSi}^{₂} − 3H_{Cr}^{SER} = 10,000 − T + 3 · GHSERCR | Du |

(Du, Zhang and Ansara as cited above) ⁰G_{V:Si}^{CrSi}^{₂} − 2H_{Si}^{SER} − H_{V}^{SER} is an adaptation of Zhang's model for chromium disilicide to describe the mixed disilicide incorporating vanadium.

TABLE 18
Model functions for V₃Si: (Si,V)₃(Si,V)₁
(Zhang as cited above)

⁰G_{Si:Si}^{V}^{₃}^{Si} − 4H_{Si}^{SER} = 208,000 − 80 · T + 4 · GHSERSI
⁰G_{V:Si}^{V}^{₃}^{Si} − H_{Si}^{SER} − 3H_{V}^{SER} = −177,099.2 +
25.88756 · T + 3 · GHSERV + GHSERSI
⁰G_{Si:V}^{V}^{₃}^{Si} − 3H_{Si}^{SER} − H_{V}^{SER} = 21,7099.2 −
25.88766 · T + GHSERV + 3 · GHSERSI
⁰G_{V:V}^{V}^{₃}^{Si} − 4H_{V}^{SER} = 20,000 + 4 · GHSERV
⁰L_{Si,V:Si}^{V}^{₃}^{Si} = ⁰L_{Si,V:V}^{V}^{₃}^{Si} = −38,908.4
⁰L_{Si:Si,V}^{V}^{₃}^{Si} = ⁰L_{V:Si,V}^{V}^{₃}^{Si} = 16,043.1 − 6.91487 · T

Table 19 lists data for melting reactions in the Si—Cr and Si—V binary systems rendered by the computational analysis outlined above. The parenthetical values are the experimentally determined binary eutectic reactions reported above. Experimental and calculated eutectic compositions were found to differ only by 2.5 at. % Si for the Si—CrSi₂ reaction and by 0.9 at. % Si for the Si—VSi₂ reaction. The melting points of Si, CrSi₂, and VSi₂ are in good agreement with literature values of Tₘ(Si)=1414° C., Tₘ (CrSi₂)=1439° C., and Tₘ(VSi₂)=1677° C. (Villars P, Okamoto H, Cenzual K, editors. ASM Alloy Phase Diagrams Center Materials Park, OH: ASM International 2007).

TABLE 19
Melting and eutectic reactions in the binary Si—CrSi₂ and
Si—VSi₂ systems

| | Composition (at. % Si) | | | |
|---|---|---|---|---|
| Reaction | L | MSi₂ | Si | Temp (° C.) |
| L → Si | — | — | 100 | 1414 |
| L → CrSi₂ | — | 66.6 | — | 1439 |
| L → CrSi₂ + Si | 85.4 | 66.6 | 100 | 1328 |
| | (87.9) | | | (1338) |
| L → VSi₂ | — | 66.6 | — | 1682 |
| L → VSi₂ + Si | 95.1 | 66.6 | 100 | 1396 |
| | (96.0) | | | (1386) |

The calculated Si—VSi₂ eutectic composition 28 and Si—CrSi₂ eutectic composition 29 are shown in FIG. 3. A calculated monovariant line 30 of solid compositions in equilibrium with a liquid phase, representing a boundary separating primary silicon and primary disilicide areas, was also calculated in the silicon-rich region 10. The Si—VSi₂ and Si—CrSi₂ binary eutectics are joined by a boundary which is the locus of liquid compositions which solidify to constitute a 100% eutectic structure comprising cubic silicon and a disilicide of vanadium and/or chromium. Under equilibrium conditions, liquid of a composition lying between the silicon vertex and the boundary first forms primary silicon upon cooling, with the composition of the remaining liquid moving toward the boundary. When the composition of the remaining liquid reaches the boundary, further solidification forms the eutectic structure, resulting in a mixed eutectic/primary silicon microstructure. Initial liquid compositions lying beyond the boundary, away from the silicon vertex, similarly solidify to form a mixed eutectic after a primary disilicide. The calculated monovariant line 30 appears to be a good approximation for the boundary in the ternary system, with agreement between the experimentally determined boundary points 21 to 26 and the line 30 being good.

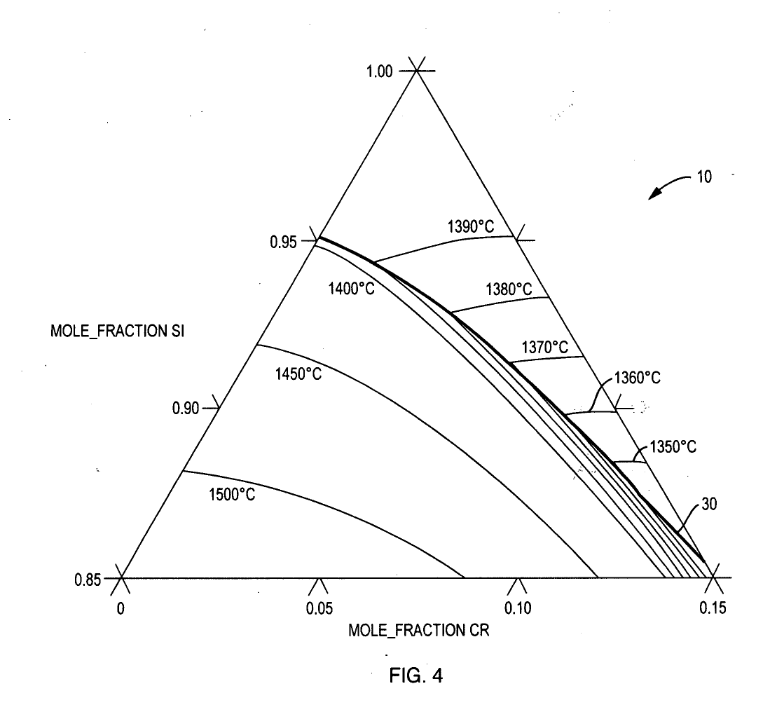

With reference to FIG. 4, liquidus projections in the silicon-rich region 10 were determined through isothermal calculations for the liquid phase. The isotherms agree well with the liquidus temperatures determined experimentally for the compositions presented in Tables 5 though 10. Agreement was closer between the calculated and measured liquidus temperatures for alloy compositions on or to the right of the monovariant line 30, i.e., in the primary Si region, whereas some deviation is found for compositions to the left of the line 30. The variability in composition of the primary disilicide phase, which leads to a much less pronounced primary endothermic peak in the measured thermal signal, may contribute to the difference as discussed above.

### Wear Testing

Binary and ternary specimens in the Si—V—Cr system were prepared for wear testing as follows. An ingot was cast for each of the compositions investigated, listed in Table 20. Preparatory to casting each ingot a graphite crucible (2.5″ ID×5″ deep, part number GT001015, graphitestore.com) and a graphite mold (inner dimensions 2.062″ W×3.75″ L×0.75″ D, part number BL001215, graphitestore.com) were baked in air at 500° C. in air for 2 hours to drive off moisture. Quantities of silicon (99.98%, Dow Corning), vanadium granules (99.7%, Alfa Aesar product #39693) and chromium pieces (2-3 mm pieces 99.995%, Alfa Aesar product #38494) as needed for the desired alloy composition were placed in the graphite crucible. The quantities were then induction melted in an air atmosphere to form a liquid alloy in the crucible. The liquid alloy was transferred into the graphite mold in an air atmosphere. After removal of the solidified ingot from the mold, flat 0.25-inch flat specimens, one inch square, were precision cut therefrom (Ferro-Ceramic Grinding, Inc.). An imaging segmentation process based on energy dispersive spectroscopy (“EDS”) was used to estimate the volume fraction of disilicide phase, reported in Table 20, in these alloys from back-scattered SEM images.

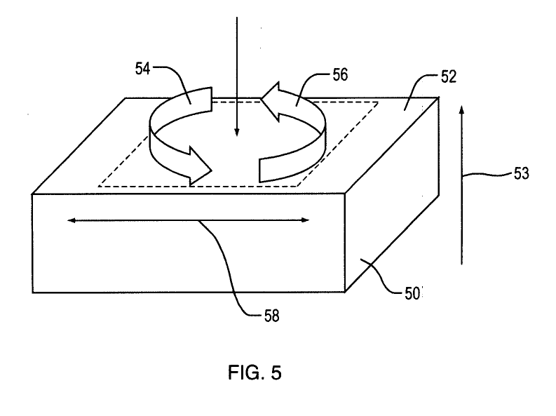

The wear behavior of unalloyed silicon and the illustrative specimens was analyzed using a ball-on-flat type tribometer (CSM Instruments, Needham, Mass.), known to those skilled in the art. A tungsten carbide ball of radius 6 mm was fixed in position above the sample stage. With reference to FIG. 5, the specimen 50 to be analyzed was attached to the sample stage and rotated in a rotation direction 54 beneath with the upper surface 52 in contact with the ball without lubrication. The radius of rotation was equal to 8 mm. The relative motion between the specimen 50 and the ball corresponded to a linear sliding velocity of 0.15 m/s. For each alloy composition tested, a distinct sample was subject to a load transmitted in a loading direction 56 through the ball. Loads used were 1 Newton, 2 N, 3 N, 4 N, 5 N and 6 N. Each sample was subjected to 10,000 cycles under load. The testing was performed in an ambient atmosphere at 25° C.±2° C. The testing apparatus was isolated within an enclosure to facilitate control of the testing environment and to reduce the effects of external noise.

It was observed that eutectic lamellae in the specimen 50 were oriented nearly perpendicular to its square upper surface 52, along a preferred growth direction 53 which correlates with the direction of maximum heat extraction rate during solidification of the ingot. After testing in the tribometer, cracks were observed in the specimens 50 under the worn upper surface 52. The cracks were due to lateral fracture, oriented in a crack direction 58 parallel to the upper surface 52 and perpendicular to the orientation of the lamellae in the preferred growth direction 53. For each specimen the normalized volume of material removed during the wear test was determined by performing a 3-D profilometry scan of the resulting wear track using a Tencor® P-16 surface profilometer with a 2-μm radius diamond stylus. A stylus force of 2 mg was used for each scan. The specimen 50 was aligned such that there was negligible curvature of the track in the area of interest, so that the scanned area of the wear track was rectangular. The scan area was 1000×300 μm, which included a total of 11 linear scans per measurement. Apex® 3D software was then used to generate a mean profile for the data. The normalized wear volume was determined by integrating to find the area A under the wear profile (as well as any pile-up areas on the sides of the wear track) using MATLAB® software. The normalized wear volume V was calculated from

$$V = \frac{v}{x} = \frac{2 π r \cdot A}{2 π r \cdot 10 , 000} = \frac{A}{10 , 000}$$

wherein v is the total wear volume, x is the total sliding distance, r is the circumference of the track. Wear areas A measured for each of the 6 loads at which tests were done. Respective area values from two different areas on the specimen wear track were averaged for each load. The normalized wear volume was used to calculate the specific wear rates kₐ=V/W, in which W is the applied load (N), shown in Table 20.

TABLE 20

| | | | Specific | |
|---|---|---|---|---|
| | Volume | | wear | |
| | percent | Load | rate | |
| Specimen composition | disili- | (New- | V/W | Kc, alloy |
| weight percents | cide | ton) | (m²/N) | Kc, Si |
| 100Si | 0 | | | 1 |
| | | 1 | 2.16 × 10⁻¹⁴ | |
| | | 2 | 2.01 × 10⁻¹³ | |
| | | 3 | 1.73 × 10⁻¹³ | |
| | | 4 | 1.87 × 10⁻¹³ | |
| | | 5 | 2.24 × 10⁻¹³ | |
| | | 6 | 2.1 × 10⁻¹³ | |
| 91.2Si—2.33Cr—4.74V | 14.9 | | | 1.95 |
| | | 1 | 1.72 × 10⁻¹⁴ | |
| | | 3 | 1.62 × 10⁻¹⁴ | |
| | | 4 | 2.56 × 10⁻¹⁴ | |
| | | 5 | 5.38 × 10⁻¹⁴ | |
| | | 6 | 7.80 × 10⁻¹⁴ | |
| 86.18Si—11.27Cr—2.55V | 20.8 | | | 1.95 |
| | | 1 | 1.74 × 10⁻¹⁴ | |
| | | 3 | 1.24 × 10⁻¹⁴ | |
| | | 4 | 1.20 × 10⁻¹⁴ | |
| | | 5 | 4.74 × 10⁻¹⁴ | |
| | | 6 | 7.08 × 10⁻¹⁴ | |
| 81.40Si—17.60Cr—1.00V | 27.4 | | | 2.32 |
| | | 1 | 1.20 × 10⁻¹⁴ | |
| | | 3 | 9.29 × 10⁻¹⁵ | |
| | | 4 | 8.71 × 10⁻¹⁵ | |
| | | 5 | 5.26 × 10⁻¹⁴ | |
| | | 6 | 6.50 × 10⁻¹⁴ | |
| 78.33Si—21.67Cr | 31.7 | | | 3.28 |
| | | 1 | 1.15 × 10⁻¹⁴ | |
| | | 3 | 9.83 × 10⁻¹⁵ | |
| | | 4 | 7.79 × 10⁻¹⁵ | |
| | | 5 | 4.34 × 10⁻¹⁴ | |
| | | 6 | 5.60 × 10⁻¹⁴ | |

The data in Table 20 indicate that all of the Si—(Cr,V)Si₂ composites display superior wear resistance compared to unalloyed silicon under all loading conditions tested. The specific wear rates of the alloys (≈10⁻¹⁴ m²/N) were found to be around an order of magnitude lower than those of Si (≈10⁻¹³ m²/N). The magnitude of the wear rates found for the composites are typical for those displayed by engineering ceramics, cermets, and nitrided steels—all of which are used in wear situations, especially when abrasive wear is of most concern.

### Toughness Testing

The room-temperature toughness of binary and ternary alloys in the Si—Cr—V system, and of bars of Hexoloy® SA silicon carbide and unalloyed silicon, was assessed using chevron-notched beam (“CNB”) tests with an A-type notch (ASTM C 1421 standard), known to those skilled in the art. In the method, a v-shaped notch is machined into a rectangular cross section of a specimen. The notch promotes automatic initiation and stable extension of a crack from the chevron tip until the point of final fracture. The CNB tests were performed on specimens in the form of 50 mm×3 mm×4 mm bars using a four-point bend fixture having outer and inner spans of 40 and 20 mm, respectively, and steel dowel pins with a diameter of 4.5±0.5 mm and length of 12.5±0.5 mm. A crosshead cylinder of an Instron 5500R testing machine in compression mode was used to push down the inner span fixture, which was guided by slats, at a rate of 0.06 mm/min. A 890 N load cell (200 lbf) with a resolution of ±10 μN (located under the stage of the Instron) was used to capture data every 0.1 sec. This capture rate is sufficient to detect smooth transitions through the maximum load, or a pop-in event followed by a subsequent force increase to the maximum load prior to failure, either of which validate the method for a given test.

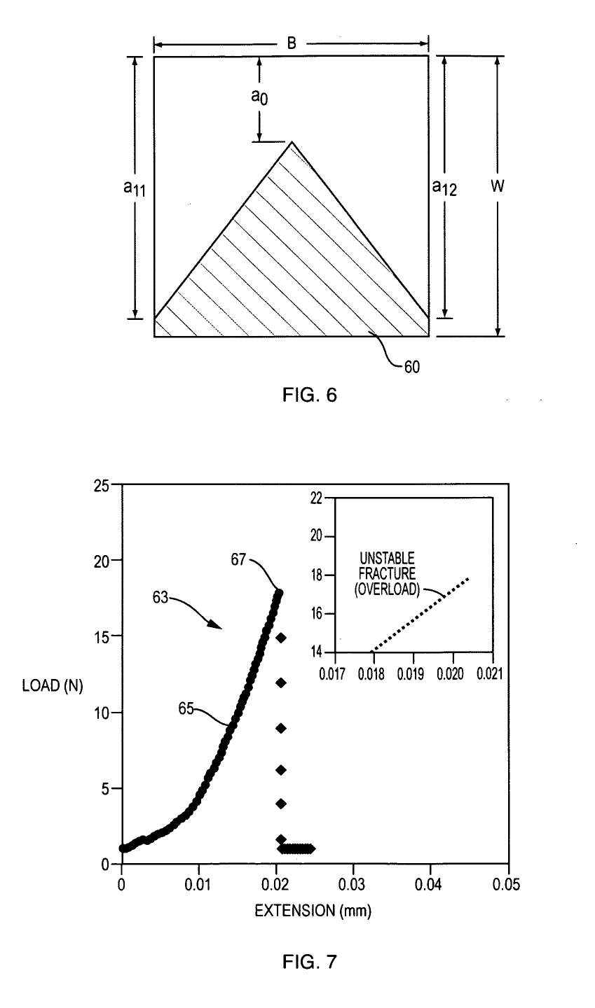

With reference to FIG. 6, for all specimens the chevron notch 60 had features of respective lengths a [symbol] (0.80±0.07 mm), a₁₁ (0.95 W to 1.00 W) and a₁₂ (0.95 W to 1.00 W) formed on the end of a specimen of width B (3.00±0.13 mm) perpendicular to and height W (4.00±0.13 mm) parallel to the expected crack line. These dimensions were found to produce the greatest relative stable crack extension to maximum load, which may allow for a near steady-state fracture toughness to be realized for rising R-curve materials, and the lowest crack velocity for a given displacement rate, facilitating detection of stable crack propagation in the silicon-based composites tested.

Based on measured maximum load values Pₘₐₓ for the CNB specimens, the fracture toughness K_{Ivb} (in MPa√m) of the composite was calculated from:

$${K}_{Ivb} = {Y}_{min}^{*} [ \frac{{P}_{max} [ {S}_{0} - {S}_{i} ] {10}^{- 6}}{{BW}^{\frac{3}{2}}} ] ,$$

as known to those skilled in the art, wherein Y*ₘᵢₙ is a stress intensity coefficient, Pₘₐₓ is the maximum force (in N) after stable crack extension, S₀ and Sᵢ are the outer and inner spans (in m) of the four-point fixture, and B and W are in meters. Y*ₘᵢₙ was calculated using the expressions derived from the straight-through-crack-assumption (Salem et al. in Ceramic Engineering and Science Proceedings 1999; 20: 503), which have been found to be good approximations of the stress intensity factor coefficient for specimen geometries with a₁/W≈1.

Pure silicon subjected to the CNB method failed catastrophically at the maximum load, with no stable crack extension observed. With reference to FIG. 7, a representative load-extension curve 63 for reference unalloyed silicon specimens has a linear portion 65 showing a consistent increase in load followed by a sudden load drop at the failure point 67. This response is indicative of crack initiation away from the tip of the chevron notch 60 (FIG. 6) due to test specimen overload and subsequent unstable fracture. Because of the unstable fracture, this CNB test could not yield a valid value of K_{Ivb} for the silicon tested.

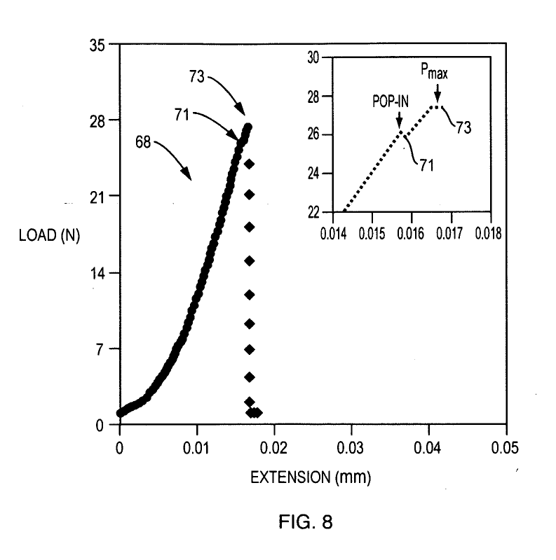

With reference to FIG. 8, a load-extension curve 68 representative of the silicon carbide specimens demonstrates a pop-in 71 prior to reaching the maximum load 73 at which catastrophic failure occurred. The pop-in 71 indicates that a sharp crack was initiated at the chevron tip and that the toughness determination results for this material were valid. A fracture toughness of 2.88±0.04 MPa·m^{1/2} was measured for Hexoloy® SA SiC which is in good agreement with known values determined by CNB testing. Catastrophic failure at maximum load is characteristic of materials that exhibit single-value toughness, or a flat R-curve. The accurate detection of stable fracture in silicon carbide and the agreement of its fracture toughness values with literature values confirm the suitability of the CNB method used for measuring K_{Ivb}.

Specimens of binary and ternary alloys in the Si—Cr—V system, of the compositions shown in Table 21, were prepared for toughness testing as follows. An ingot was cast in an induction furnace for each composition investigated. For each ingot to be cast a graphite crucible (GR030, graphitestore.com) was baked at 540° C. for 30 min in the induction coil and then allowed to cool, all while being pumped under vacuum (3×10⁻² ton). A graphite mold (GM-111, graphitestore.com), of dimensions shown in Table 22, was baked at 430° C. for 45 min in an air atmosphere and then fan cooled. When the crucible and mold had both reached room temperature, the crucible was charged with silicon chunks (99.98%, Dow Corning), chromium pellets (99.96 wt. %, Sophisticated Alloys Inc.), and vanadium chips (99.86 wt. %, Sophisticated Alloys Inc.) in appropriate ratios. The mold and crucible were placed in the induction furnace, which was pumped down to 5×10⁻⁵ torr and backfilled with argon. The crucible was held by the induction coils during melting of the charge, effected by operating the furnace at 70 kW, 800 V, and 2300 Hz. When the charge was liquid the coils were tilted to transfer the molten alloy into the mold in the argon atmosphere of the induction furnace. The casting was allowed to cool for 1 hour prior to opening the induction furnace chamber. Bars were precision machined from the cast ingots by electric discharge machining (Bomas Machine Specialties, Inc., Somerville, Mass.) as described below.

TABLE 21

| Alloy | Alloy Composition (wt. %) | | |
|---|---|---|---|
| Designation | Si | Cr | V |
| A | 93.00 | 0.00 | 7.00 |
| B | 87.24 | 7.72 | 5.04 |
| C | 82.68 | 13.91 | 3.41 |
| D | 79.71 | 20.29 | 0.00 |

TABLE 22

| | Outside | Inside | Outside | Inside | | |
|---|---|---|---|---|---|---|
| | Length | Length | Width | Width | Height | Depth |
| Alloy(s) | (cm) | (cm) | (cm) | (cm) | (cm) | (cm) |
| A, B, D | 43.18 | 33.02 | 22.86 | 12.70 | 16.51 | 11.43 |
| C | 20.96 | 17.15 | 12.70 | 8.89 | 6.99 | 5.08 |

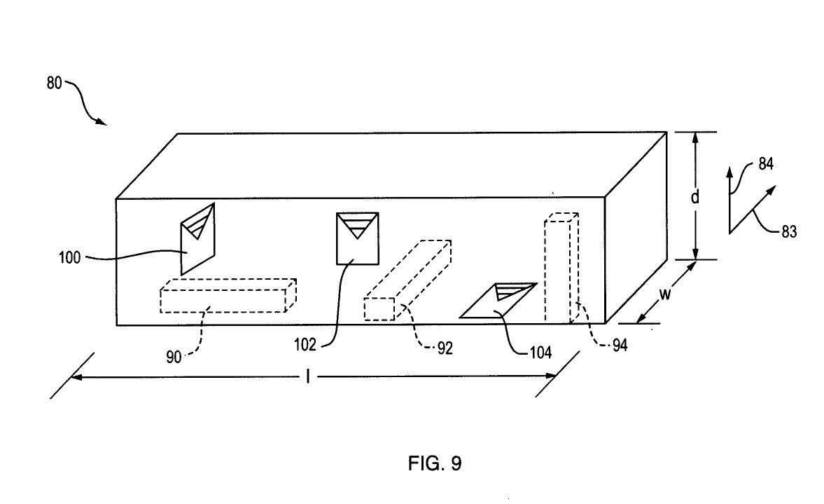

For clarity of illustration, FIG. 9 shows a form 80 having a length 1, width w and depth d representing the interior of a graphite mold in which a specimen ingot was cast.

Due to differences in area, during solidification it is expected that heat is extracted at a greater rate through the faces of the form 60, defined respectively by the length 1 and width w and by the length 1 and depth d, than through the ends, defined by the width w and depth d. Accordingly the solidification front moves least rapidly away from the ends, so that disilicide bodies may be preferentially oriented along two perpendicular dimensions 83 and 84. The eutectic structure produced may thus be oriented differently with respect to the dimensions of a specimen depending on whether it was cut from a first orientation 90, a second orientation 92, and a third orientation 94 in the ingot.

Table 23 summarizes the specimen types tested. Respective specimens of the alloys designated A and B were prepared from the center region of the ingots and only in the third orientation 94. Specimens of the alloy designated C were machined from the center region of the smaller ingots and only in the second orientation 92. Four specimen types were tested for the alloy Si—Cr composition designated alloy D. Alloy D specimens were machined from the center of ingots in the third orientation 94 and from material near the mold walls, where solidification occurs at a relatively high rate, in each of the first orientation 90, second orientation 92, and third orientation 94.

With reference to FIG. 6 and FIG. 9, notches 60 in a first notch plane 100, a second notch plane 102 and a third notch plane 104 were formed in specimens cut from respective orientations 90, 92 and 94. Specimens machined in either of the second orientation 92 and third orientation 94 are thus set up with respective notch planes 102 and 104 oriented perpendicular to one of the likely preferred disilicide growth directions 83 and 84, whereas a specimen machined in the first orientation 90 has a notch plane 100 oriented parallel to both of the growth directions 83 and 84.

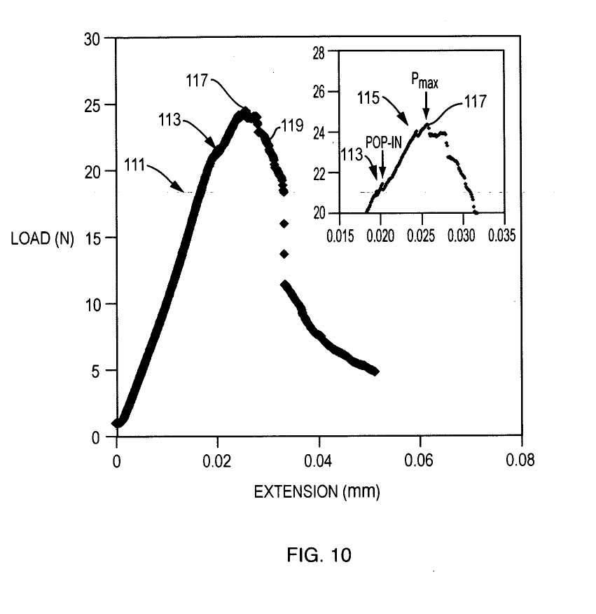

With reference to FIG. 10 the Si—(Cr,V)Si₂ alloy designated C demonstrated a load-extension response 111 typical of the tested alloys during the CNB testing. An initial pop-in 113 indicated that a sharp crack was initiated at the chevron tip and that the tests on this material were valid. After the initial pop-in 113 and a climb 115 representing stable propagation of the crack with increasing load, and a smooth transition through the maximum load Pₘₐₓ 117 was observed. In contrast to both silicon and silicon carbide, the non-catastrophic fracture response for the alloys, shown by a gradual decrease 119 in load after stable crack propagation through the maximum load 117, can be attributed to a rising R-curve behavior, or an increase in crack resistance with crack growth. The small perturbations in the load-extension curve 111 near the maximum load 117 most likely correspond to fracturing of the disilicide reinforcements within the bridging zone of the crack wake during propagation.

Table 23 lists the fracture toughness values calculated from the test data for each of the different specimen types tested. For each specimen type, both the range of values and average value of K_{Ivb} is reported. The value in parentheses after an average fracture toughness values indicates the number of valid measurements used to compute the average. All of the Si—(Cr,V)Si₂ composites tested showed fracture toughness values greater than 2 MPa·m^{1/2} which is greater than twice that cited for unalloyed silicon (˜0.8-1.0 MPa·m¹²).

TABLE 23

| | Sample | | | | |
|---|---|---|---|---|---|
| | Orien- | Region | Avg. K_{Ivb} | Min. K_{Ivb} | Max. K_{Ivb} |
| Material | tation | of ingot | (MPa√m) | (MPa√m) | (MPa√m) |
| Silicon | N/A | — | Invalid | — | — |
| Hexoloy ® | N/A | — | 2.88 ± 0.04 (4) | 2.85 | 2.93 |
| SA SiC | | | | | |
| Alloy A | Third | Center | 2.06 ± 0.36 (7) | 1.63 | 2.43 |
| Alloy B | Third | Center | 2.26 ± 0.45 | 1.58 | 3.05 |
| | | | (11) | | |
| Alloy C | Second | Center | 2.34 ± 0.37 | 1.77 | 2.86 |
| | | | (10) | | |
| Alloy D | Third | Center | Invalid | — | — |
| Alloy D | Third | Side | 2.40 ± 0.22 (3) | 2.14 | 2.55 |
| Alloy D | Second | Side | 2.61 ± 0.15 (4) | 2.46 | 2.77 |
| Alloy D | First | Side | 2.15 ± 0.13 (5) | 2.02 | 2.26 |

During CNB testing of specimens machined in the third orientation 94 from the center of the alloy D castings, two types of behaviors were observed. In the specimens having disilicide reinforcements near the notch walls parallel to the crack direction, from which little toughening due to interface-crack interaction would be expected, fracture only occurred near the sides of the notch plane. In the specimens having disilicide reinforcements aligned perpendicular to the crack direction, consistent with significant toughening by interface-crack interaction, a high degree of crack deflection and bridging resulted in the deflection of the crack out of the notch plane. Both behaviors were incompatible with a valid determination of the fracture toughness for the specimens of the central portion of the D alloy by the CNB method used.

Microstructural analysis was performed on CNB specimens after testing. For each specimen type, three broken beams were sectioned at a distance of about 2-3 mm behind the notch plane and metallographically prepared by grinding and polishing. Scanning electron microscope images were taken using back-scattered imaging.

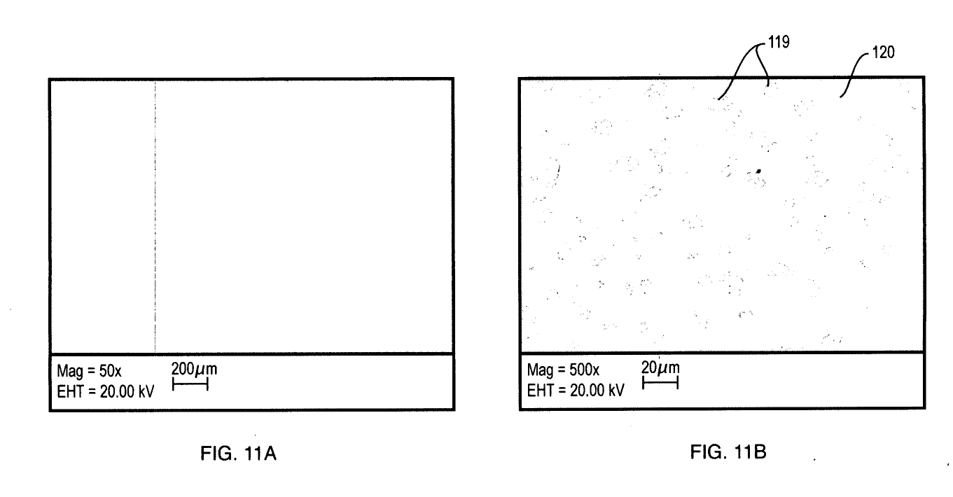

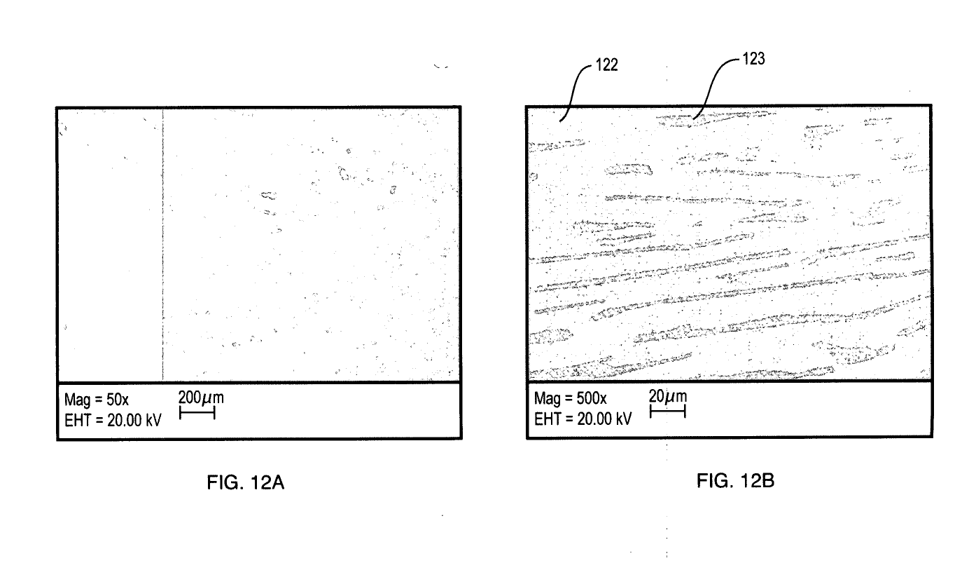

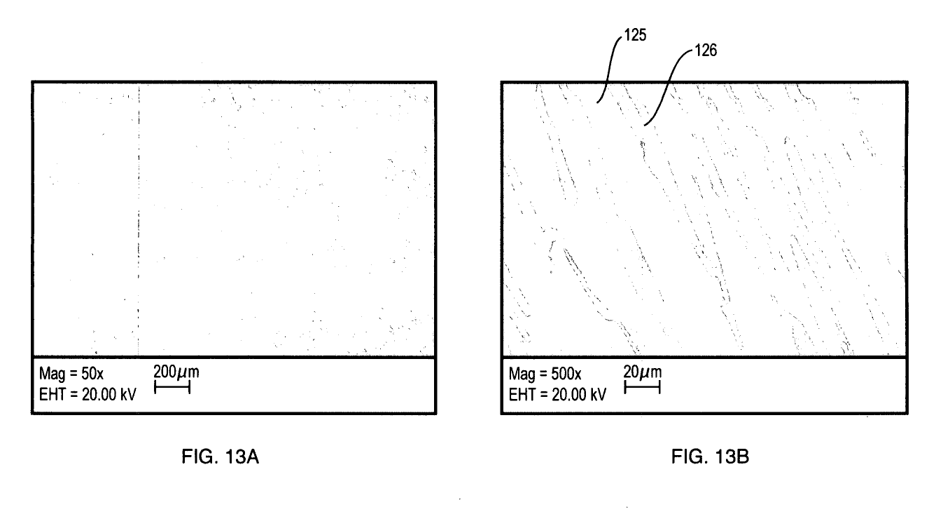

With reference to FIGS. 11A and 11B, the microstructure in the eutectic aggregation of alloy A is generally fibrous. The microstructure incorporates vanadium disilicide particles 120 that are mostly rod-like with some unbranched plates in a cubic silicon matrix 121. With reference to FIGS. 12A and 12B, the eutectic aggregation of alloy B has an irregular structure composed of silicon 122 and massive branched and unbranched plates 122 of the (Cr,V)Si₂ phase. With reference to FIGS. 13A and 13B, the eutectic aggregation of alloy C has an irregular structure of silicon 125 with branched plates 126 with a small amount of complex-regular structure appearing as small, island-like clusters (not shown). The alloy-C microstructure is similar to that of alloy B, except that in alloy C the arrangements of the plates 126 are regular over larger areas.

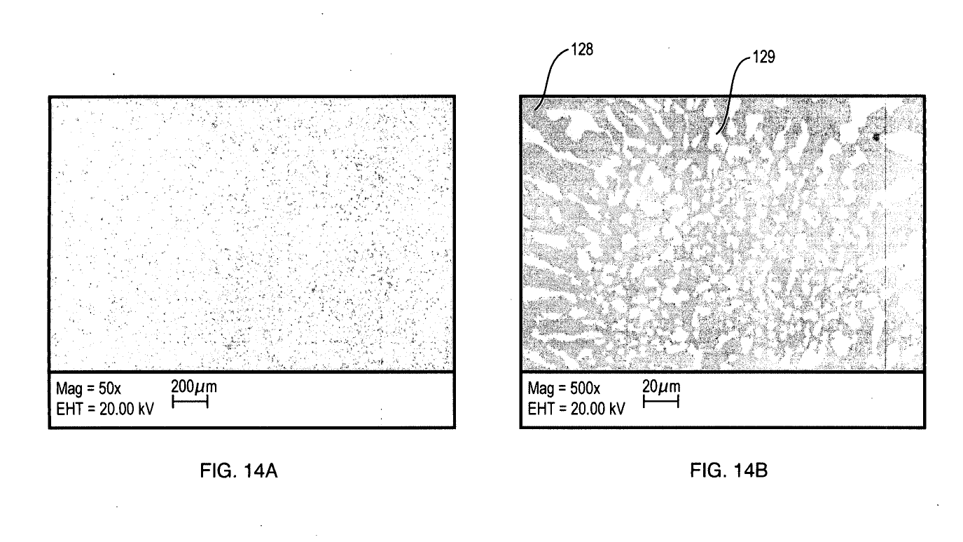

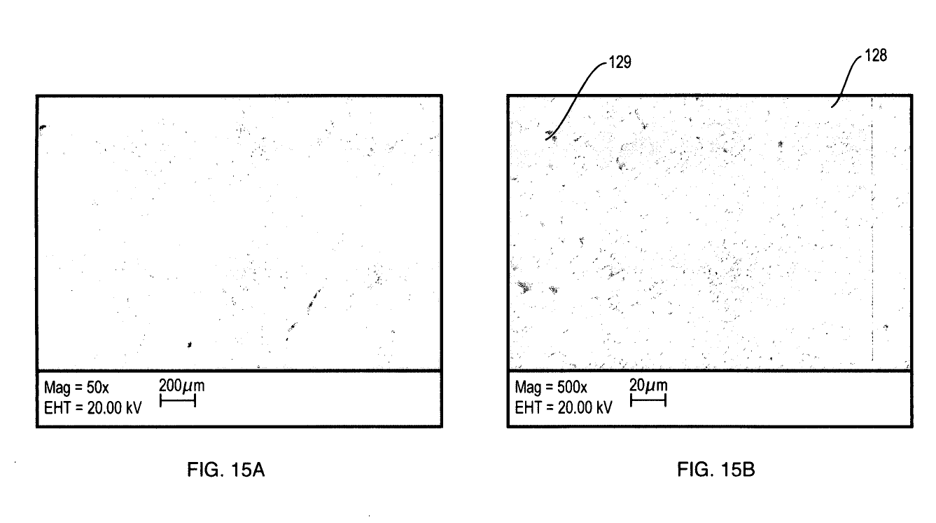

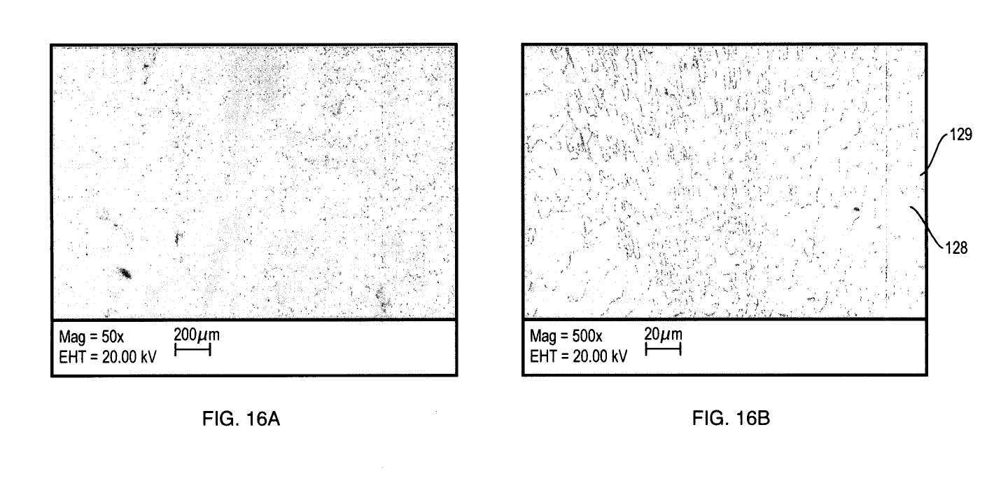

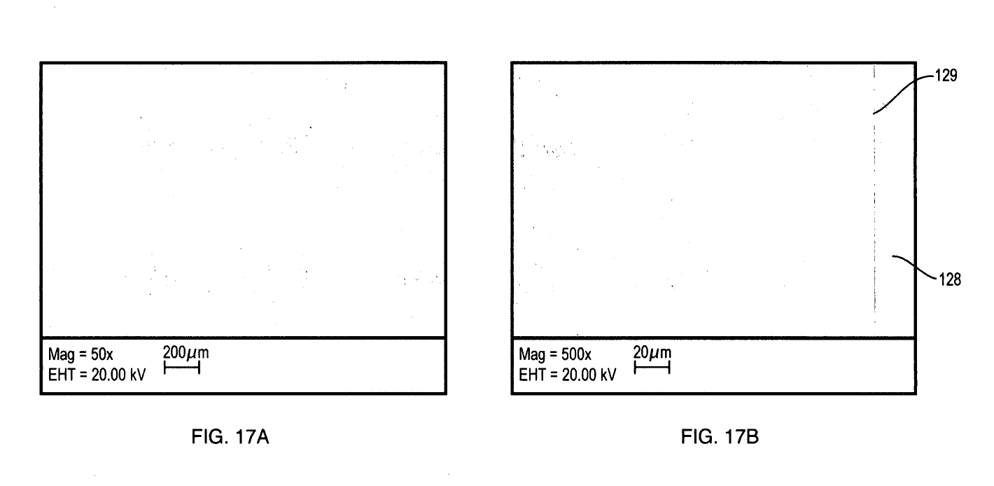

With reference to FIGS. 14A and 14B, specimens of alloy D machined from the center of the castings show a eutectic pseudo-colony type structure of silicon 128 and a chromium disilicide phase 129 having a high degree of alignment about one of the preferred growth directions 83 and 84 (FIG. 9). Specimens of alloy D machined from the side of the casting have a similar colony-type structure of silicon and chromium disilicide observed as for the center alloy D specimens, represented in FIGS. 14A-B, but with large silicon regions present, apparently from silicon overgrowth during relatively rapid solidification near the mold wall. With reference to FIGS. 15A-B, FIGS. 16A-B, and FIGS. 17A-B represent respectively specimens of alloy D machined in the third orientation 94, second orientation 92, and third orientation 90, shown parallel to their respective notch planes 104, 102 and 100. The alloy D specimens of the third and second orientations 94 and 92 have a higher fraction of their chromium disilicide oriented substantially perpendicular to their respective notch planes than does the specimen of the first orientation 90.

The volume fraction of the disilicide phase was determined using an imaging segmentation process based on EDS on back-scattered SEM images. The volume fractions of disilicide measured for each of the alloys A-D in this manner are listed in Table 24. For alloy D, measurements are given both for the specimens machined from the center of the casting and from the sides of the casting. For specimens machined from the center of their respective ingots, the alloys increase in disilicide volume fractions in the order A B C, the same order in which those alloys increase in fracture toughness.

TABLE 24

| Alloy | Volume percent disilicide |
|---|---|
| A | 6.68 ± 0.9 |
| B | 19.86 ± 0.8 |
| C | 23.82 ± 0.9 |
| D—center | 39.61 ± 2.3 |
| D—sides: average of notch | 31.33 ± 7.1 |
| planes 100, 102,104 | |

In most cases, the measured volume fraction of disilicide reported in Table 24 is around 2-7% lower than that expected from equilibrium solidification calculations. This may be due to solute segregation during non-equilibrium solidification. In the case of rapid solidification, substantial diffusion in the solid may not be possible, so that rejection of solute into the liquid during primary solidification, for off-eutectic alloys, gives rise to a concentration gradient in the casting. Such compositional gradients can cause global and local variations of the microstructure throughout the casting. This appears to have occurred in specimens of alloy D. Alloy D specimens taken from the center of the casting, which solidifies last, showed a significantly higher volume fraction of disilicide than those machined from the sides of the casting.

For specimens of alloys A, B, and C displaying the highest and lowest fracture toughness values, transverse images of the notch tip regions were made from CNB specimens. Each of the specimens having the maximum measured toughness value for its alloy composition show a rough fracture surface, evident of a high degree of crack deflection and bridging. The microstructure surrounding the notch appears to be fully or near-fully eutectic.

In each specimen having minimum measured toughness values for its alloy composition, large silicon regions, which appear to be due to overgrowth, are present around the notch tip. Large silicon regions provide little fracture resistance during the initial stages of crack growth. Since no bridging zones form in the wake of the crack during the initial stages of crack growth, the stress intensity may become be too high for any eutectic structure present in the middle or base of the notch region to contribute meaningful toughening.

The characteristic spacing of the microstructure, not excluding regions not in eutectic aggregation, was measured in these notch regions using a linear intercept procedure, known to those skilled in the art. For each specimen, five measurements of the characteristic spacing λ of the disilicide-silicon eutectic structures were made in the notch plane for a distance of 1600 μm from the notch tip. The spacing values are shown in Table 25. The specimens displaying the maximum toughness for their respective specimen set had significantly smaller disilicide spacings than their counterparts having the minimum toughness.

TABLE 25

| | Fracture Toughness | Disilicide Spacing |
|---|---|---|
| Specimen | (MPa√m) | (μm) |
| Alloy A (min toughness) | 1.63 | 70 ± 20 |
| Alloy A (max toughness) | 2.43 | 36 ± 2 |
| Alloy B (min toughness) | 1.58 | 88 ± 8 |
| Alloy B (max toughness) | 3.05 | 39 ± 4 |
| Alloy C (min toughness) | 1.77 | 41 ± 6 |
| Alloy C (max toughness) | 2.86 | 30 ± 4 |

Toughness of the brittle-brittle composites may be enhanced by the presence of a phase capable of plastic flow. Quaternary compositions incorporating a ductile phase in brittle-brittle eutectic Si-silicide composites were made by addition of a ductile metallic element. For the Si—Cr—V system, candidate metals for addition, not forming an intermediate compound with either silicon, chromium or vanadium, are silver and tin.

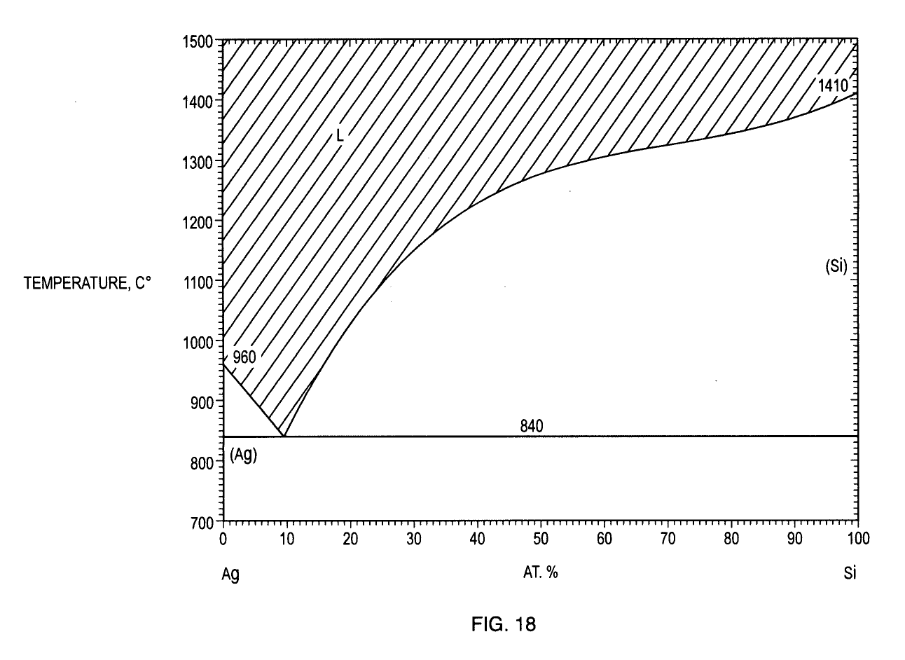

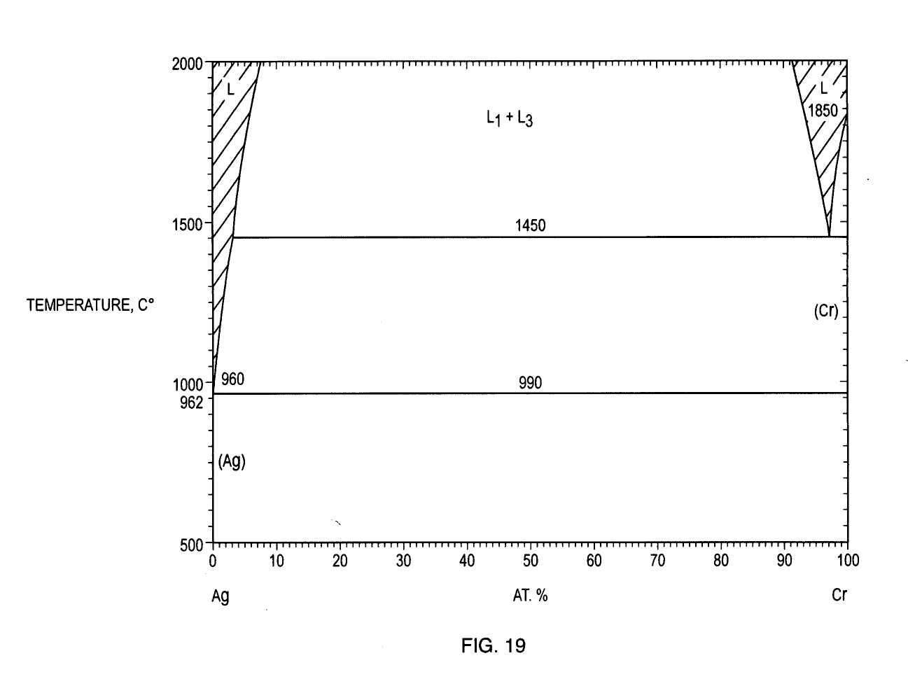

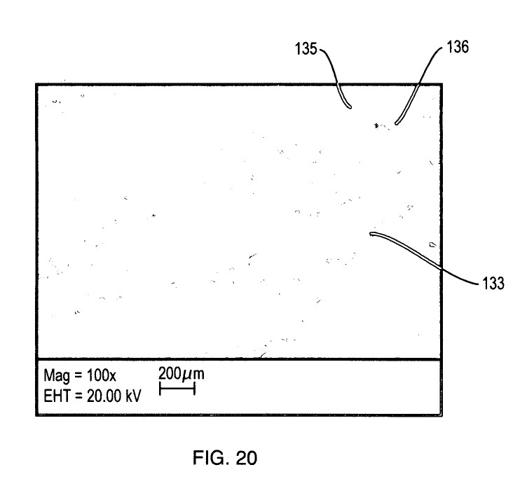

With reference to FIG. 18, silver forms a single eutectic with silicon at around 9 at % Si. With reference to FIG. 19, silver shows a miscibility gap with chromium over the entire composition range. Composites containing Si—SiCr₂ eutectic were prepared from a liquid having composition Si-17.7 Cr-6.7 Ag (wt. %). Silver in the resulting Si-rich composite was observed to form a low-melting eutectic structure with Si. With reference to FIG. 20, the silver-silicon eutectic 133 was located either within the lamellar structure of the eutectic aggregation of silicon 135 and chromium disilicide 137 or at the boundaries of the eutectic aggregation.

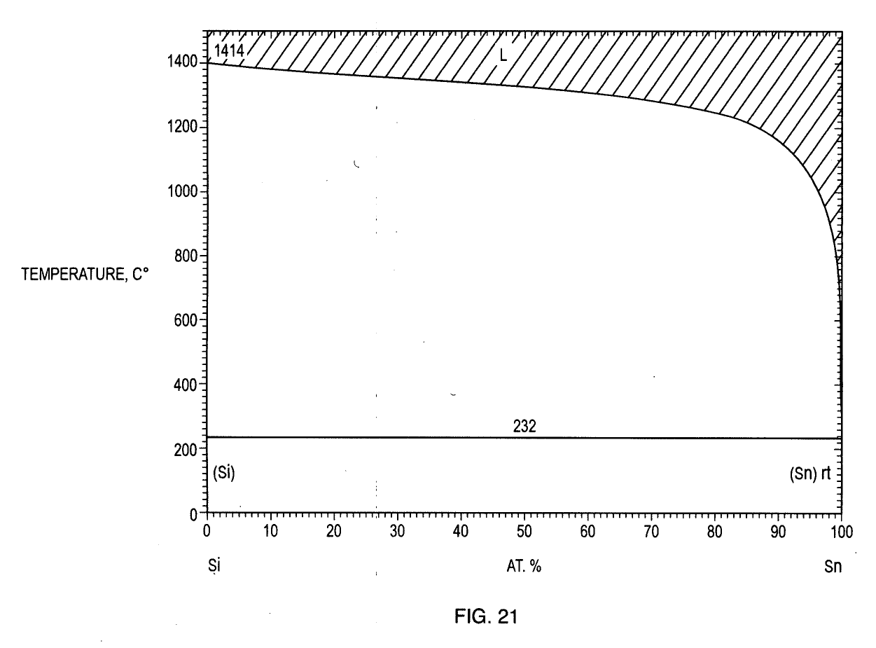

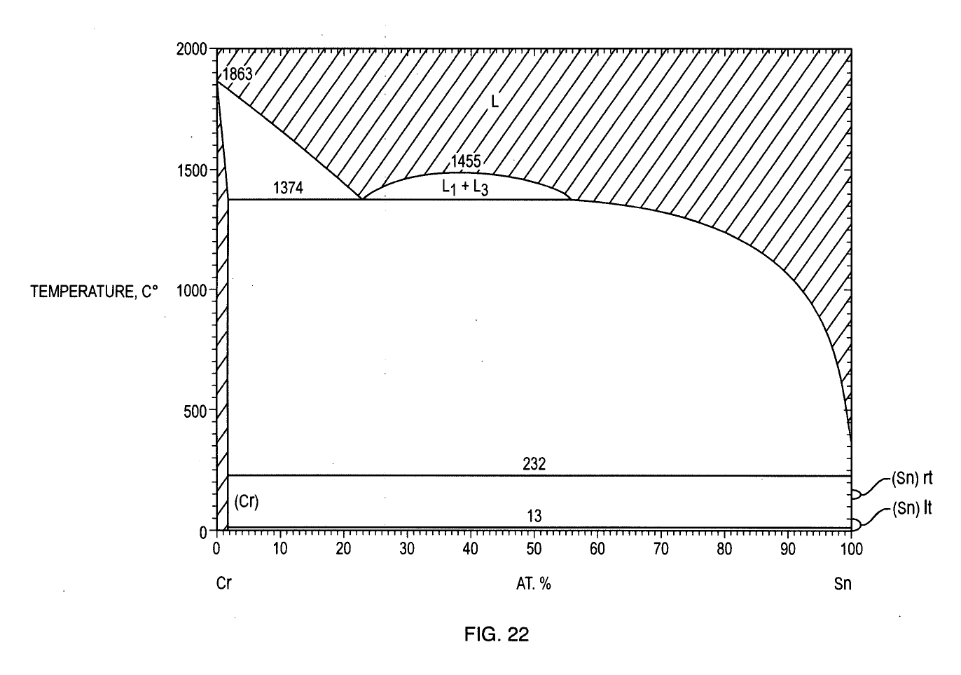

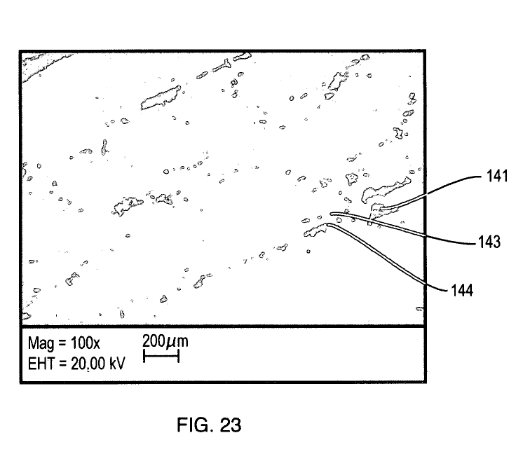

With reference to FIG. 21, tin forms a miscibility gap with Si over the entire composition range, i.e., the eutectic composition is of negligible Si content. With reference to FIG. 22, tin is soluble in chromium up to a concentration of about 2 at % Sn, above which tin is immiscible with Cr. Composites containing Si—SiCr₂ eutectic aggregation were prepared from a liquid having composition Si-17.6 Cr-7.3 Sn (wt. %). With reference to FIG. 23, the tin is segregated in a tin phase 141 at boundaries of colonies of the eutectic structure of silicon 143 and Si—CrSi₂ 144.

Although specific features are included in description of some embodiments and not in others, it should be noted that individual feature may be combinable with any or all of the other features in accordance with the invention. Furthermore, other properties may be compatible with the described features.

It will therefore be seen that the foregoing represents a highly advantageous approach to forming silicon-based materials, particularly as lightweight composites demonstrating toughness at room temperature. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. An object formed by
melting silicon and at least one element together to form a liquid having a silicon concentration greater than 50% silicon by weight;
disposing the liquid in a mold; and
cooling the liquid, thereby simultaneously forming cubic silicon and a silicide arranged in a eutectic aggregation, constituting at least 80% by volume of the object, in the mold.

2. The object of claim 1 wherein the object exhibits a rising R-curve.

3-5. (canceled)

6. The object of claim 1 wherein interfaces between cubic silicon and the silicide are capable of delaminating when encountered by a crack.

7. A method of forming a cast object, comprising:
melting silicon and at least one element together to form a liquid having a silicon concentration greater than 50% silicon by weight;
disposing the liquid in a mold; and
cooling the liquid, thereby simultaneously forming cubic silicon and a silicide arranged in a eutectic aggregation, constituting at least 80% by volume of the object, in the mold.

8. The method of claim 7 wherein the object exhibits a rising R-curve.

9-13. (canceled)

14. A composition of matter comprising:
a phase of cubic silicon; and
a phase comprising a first element other than silicon, arranged in a eutectic aggregation with the phase of cubic silicon, constituting 80% or more of the composition of matter by volume,
wherein the composition of matter exhibits a rising R-curve and has a silicon concentration greater than 50% by weight.

15. The composition of matter of claim 14 wherein the composition of matter has a fracture toughness of at least 1.2 MPa m½.

16-17. (canceled)

18. The composition of matter of claim 14 wherein the composition of matter exhibits a rising R-curve at 25° C.

19. The composition of matter of claim 14 wherein the composition of matter is a casting.

20. The composition of matter 14 wherein the phase of cubic silicon and the phase comprising a first element other than silicon are arranged in an anomalous eutectic structure.

21. The composition of matter of claim 14 wherein the eutectic aggregation includes local domains of diverse orientation.

22. The composition of matter of claim 14 wherein the phase comprising a first element other than silicon is a mixed disilicide phase including a second element.

23-25. (canceled)

26. The composition of matter of claim 14 wherein the composition comprises a metallically bonded phase capable of plastic flow.

27. (canceled)

28. A composition of matter comprising:
a phase of cubic silicon; and
a first silicide phase comprising a first element other than silicon, arranged in a eutectic aggregation with the phase of cubic silicon constituting 80% or more of the composition of matter by volume, the eutectic aggregation having a characteristic spacing λ,
wherein the composition of matter has a silicon concentration greater than 50% by weight, a thickness greater than 10λ, and a fracture toughness greater than 1.2 MPa m^{1/2}.

29-42. (canceled)

43. The composition of matter of claim 28 wherein the first element is one of vanadium, chromium, niobium, and tantalum.

44. The composition of matter of claim 28 wherein the first element is one of titanium, zirconium, hafnium, thallium, molybdenum, tungsten, iron, osmium, cobalt, nickel, strontium, and magnesium.

45. The composition of matter of claim 28 wherein the first element is one of scandium and yttrium.

46. The composition of matter of claim 28 wherein the first element is one of manganese and rhenium.

47. The composition of matter of claim 28 wherein the first element is a transition metal.

48. The composition of matter of claim 28 wherein the first element is an alkali or alkaline earth metal.

49-51. (canceled)

52. The composition of matter of claim 28 wherein the first silicide phase further comprises a second element other than silicon.

53. The composition of matter of claim 52 wherein the first element is vanadium and the second element is chromium.

54-57. (canceled)

58. The composition of matter of claim 28 further comprising a second silicide phase arranged in the eutectic aggregation.

59. The composition of matter of claim 28 wherein the eutectic aggregation comprises two phases.

60-63. (canceled)

64. The composition of matter of claim 28 wherein the composition of matter exhibits a rising R-curve.

65. The composition of matter of claim 28 wherein the first silicide phase and the phase of cubic silicon are simultaneously formed by cooling a liquid.

66-67. (canceled)

68. The composition of matter of claim 28 wherein the composition of matter has a specific wear rate no greater than 5×10⁻¹⁴ m²/N as determined by a ball-on-disk test with a tungsten carbide counterbody.

69. (canceled)

70. A composition of matter comprising:
a phase of cubic silicon; and
a first silicide phase comprising a first element other than silicon, arranged with the phase of cubic silicon in a eutectic aggregation constituting 80% or more of the composition of matter by volume, the eutectic aggregation having a characteristic spacing λ,
wherein the composition of matter has a silicon concentration greater than 50% by weight and a thickness greater than 100λ.

71. A composition of matter comprising:
a phase of cubic silicon; and
a first disilicide phase comprising a first element other than silicon, arranged with the phase of cubic silicon in a eutectic aggregation constituting 80% or more of the composition of matter by volume, the eutectic aggregation having a characteristic spacing λ,
wherein the composition of matter has a silicon concentration greater than 50% by weight and a thickness greater than 10λ.

72. The composition of matter of claim 71 wherein the composition of matter exhibits a rising R-curve.

73-84. (canceled)

85. The composition of matter of claim 71 wherein
the first disilicide phase is a mixed disilicide further comprising a second element other than silicon,
a first eutectic composition exists between silicon and a disilicide of the first element,
a second eutectic composition exists between silicon and a disilicide of the second element, and
liquid compositions lying on a curve joining the first eutectic composition and the second eutectic composition undergo eutectic solidification upon cooling.

86. The composition of claim 85 wherein
a disilicide of the first element, a disilicide of the second element, and
the first disilicide phase exist in a common crystal structure.

87. (canceled)

88. The composition of matter of claim 85 wherein silicon, the first element and the second element are present in respective concentrations each within two atomic percent of respective concentrations of silicon, the first element, and the second element at a point on the curve.

89. (canceled)

90. The composition of matter of claim 89 wherein the mixed disilicide further comprises one of niobium and tantalum.

91. The composition of matter of claim 88 wherein the first element is niobium and the second element is tantalum.

92-98. (canceled)

99. The composition of matter of claim 71 wherein the composition of matter has a specific wear rate no greater than 5×10⁻¹⁴ m²/N as determined by a ball-on-disk test with a tungsten carbide counterbody.

100. A composition of matter comprising:
silicon at a concentration greater than about 50% by weight;
vanadium; and
chromium,
at respective concentrations each within two atomic percent of respective concentrations of silicon, vanadium and chromium at a point on a curve joining a eutectic composition between silicon and vanadium disilicide and a eutectic composition between silicon and chromium disilicide, liquids lying on the curve undergoing eutectic solidification upon cooling, wherein the composition of matter exhibits a rising R-curve.

101-103. (canceled)

104. The composition of matter of claim 100 wherein the composition of matter has a fracture toughness, determined by a particular method, greater than twice the fracture toughness of silicon, determined by the same method.

105. The composition of matter of claim 101 wherein the two-phase eutectic aggregation comprises tantalum or niobium.

106. The composition of matter of claim 100 where the respective concentrations of silicon, vanadium and chromium are each within one atomic percent of respective concentrations of silicon, vanadium and chromium at a point on the curve.
